(19) United States
(12) Patent Application Publication
(10) Pub. No.: US 2021/0357723 A1
(43) Pub. Date: Nov. 18, 2021

(54) Distributed Processing System and Distributed Processing Method

(71) Applicant: Nippon Telegraph and Telephone Corporation, Tokyo (JP)

(72) Inventors: Kenji Kawai, Tokyo (JP); Junichi Kato, Tokyo (JP); Huycu Ngo, Tokyo (JP); Yuki Arikawa, Tokyo (JP); Kenji Tanaka, Tokyo (JP); Takeshi Sakamoto, Tokyo (JP); Tsuyoshi Ito, Tokyo (JP)

(21) Appl. No.: 17/291,229

(22) PCT Filed: Oct. 23, 2019
(86) PCT No.: PCT/JP2019/041482

§ 371 Date: May 4, 2021

(30) Foreign Application Priority Data
Nov. 6, 2018 (JP) 2018-208721

(51) Int. Cl. G06N 3/04; G06N 3/08

(52) U.S. Cl. CPC G06N 3/04; G06N 3/08

(57) ABSTRACT

A distributed processing system includes a plurality of lower-order aggregation networks and a higher-order aggregation network. The lower-order aggregation networks include a plurality of distributed processing nodes disposed in a ring form. The distributed processing nodes generate distributed data for each weight of a neural network of an own node. The lower-order aggregation networks aggregate, for each lower-order aggregation network, the distributed data generated by the distributed processing nodes. The higher-order aggregation network generates aggregated data where the aggregation results of the lower-order aggregation networks are further aggregated, and distributes to the lower-order aggregation networks. The lower-order aggregation networks distribute the aggregated data distributed thereto to the distributed processing nodes belonging to the same lower-order aggregation network. The distributed processing nodes update weights of the neural network based on the distributed aggregated data.

This patent application is a national phase filing under section 371 of PCT/JP2019/041482, filed Oct. 23, 2019, which claims the priority of Japanese patent application no. 2018-208721, filed Nov. 6, 2018, each of which is incorporated herein by reference in its entirety.

### TECHNICAL FIELD

The present invention relates to a distributed processing system that is provided with a plurality of distributed processing nodes, and in particular relates to a distributed processing system and a distributed processing method that aggregate numerical value data from the distributed processing nodes and generate aggregated data, and distribute the aggregated data to the distributed processing nodes.

### BACKGROUND

In deep learning, regarding a learning target made up of a multilayer neuron model, a weight (a coefficient to multiply with a value that an upstream neuron model has output) for each neuron model is updated on the basis of input sample data, thereby improving inference accuracy.

The mini-batch method is commonly used as a technique to improve inference accuracy. In the mini-batch method, gradient calculation processing where a gradient is calculated for the weight for each piece of sample data, aggregation processing where the gradient is aggregated for a plurality of different pieces of sample data (gradients acquired for each piece of sample data are added by weight), and weight updating processing where the weights are updated on the basis of the aggregated gradients, are repeated.

These types of processing, particularly gradient calculation processing, require a great number of times of computation. There is a problem in that increasing the count of weights and the count of sample data that is input, in order to improve inference accuracy, increases the amount of time required for deep learning.

The distributed processing technique is used to increase the speed of gradient calculation processing. Specifically, a plurality of distributed processing nodes are provided, with each node performing gradient calculation processing regarding different sample data from each other. Accordingly, the count of sample data that can be processed per unit time can be increased proportionately to the number of nodes, and thus the speed of gradient calculation processing can be increased (see NPL 1).

In order to perform aggregation processing in distributed processing for deep learning, communication is necessary among the gradient calculation processing of calculating a gradient regarding weight for each sample data, in-node aggregation processing where gradients acquired for each sample data are added by weight, and weight updating processing of updating the weights on the basis of the aggregated gradients, performed by each distributed processing node. This communication includes communication for transferring data acquired at each distributed processing node (distributed data) to nodes to perform aggregation processing (aggregation communication), processing of aggregating on the basis of data acquired by the aggregation communication (inter-node aggregation processing), and communication for distributing the aggregated data acquired from each of the distributed processing nodes (aggregated data) to each of the distributed processing nodes (distribution communication).

This time necessary for aggregation communication and distribution communication is unnecessary in systems where deep learning is carried out by a singular node and is a factor that reduces processing speed in distributed processing for deep learning.

In recent years, deep learning has come to be applied to even more complicated problems, and there is a tendency for the total count of weights to increase. Accordingly, the amount of data of distributed data and aggregated data is increasing, and the aggregation communication time and the distribution communication time are increasing.

Thus, there has been a problem in distributed processing systems for deep learning, in that increasing the number of distributed processing nodes reduces the effects of high speeds of deep learning, due to the increase in aggregation communication time and the distribution communication time.

FIG. 14 illustrates a relation between the number of distributed processing nodes and processing performance of deep learning in a conventional distributed processing system, in which reference number 200 represents an ideal relation between the number of distributed processing nodes and processing performance (performance∝number of nodes), and reference number 201 represents the actual relation between the number of distributed processing nodes and processing performance. The reason why the total amount of distributed data, which is the input for inner-node aggregation processing, increases proportionately to the number of distributed processing nodes, but the actual processing performance does not improve proportionately to the number of distributed processing nodes, is that the communication speed of aggregation processing nodes is limited to no faster than the physical speed of the communication ports of these nodes, and the amount of time necessary for aggregation communication increases.

### CITATION LIST

### Non Patent Literature

[NPL 1] Takuya Akiba, “Bunsanshinso Gakushu Pakkeji ChainerMN Kokai (Distributed Deep Learning Package ChainerMN Release)”, Preferred Infrastructure, 2017, Internet<https://research.preferred.jp/2017/05/chainermn-beta-release/>.

### SUMMARY

### Technical Problem

Embodiments of the present invention have been made in light of the above-described situation, and it is an object hereof to provide a distributed processing system and a distributed processing method capable of performing effective distributed processing when applied to deep learning, in a distributed processing system provided with a plurality of distributed processing nodes.

### Means for Solving the Problem

A distributed processing system according to embodiments of the present invention includes a plurality of lower-order aggregation networks and a higher-order aggregation network that connects between the plurality of lower-order aggregation networks. Each of the lower-order aggregation networks includes at least a plurality of distributed processing nodes disposed in a ring form. The distributed processing nodes belonging to the lower-order aggregation networks each generate distributed data for each weight of a neural network that is a learning target of an own node. The lower-order aggregation networks aggregate, for each lower-order aggregation network, the distributed data generated by the distributed processing nodes belonging to the lower-order aggregation networks. The higher-order aggregation network generates aggregated data where the aggregation results of the lower-order aggregation networks are further aggregated, and distributes to the lower-order aggregation networks. The lower-order aggregation networks distribute the aggregated data distributed by the higher-order aggregation network to the distributed processing nodes belonging to a same lower-order aggregation network. The distributed processing nodes belonging to the lower-order aggregation networks update weights of the neural network on the basis of the distributed aggregated data.

Also, a distributed processing system according to embodiments of the present invention includes M (where M is an integer of 2 or greater) lower-order aggregation networks, and a higher-order aggregation network that connects between the M lower-order aggregation networks. The lower-order aggregation networks are configured of N[m] (m=1, . . . , M, where N[m] is an integer of 2 or greater) distributed processing nodes disposed in a ring form, and a lower-order communication path that connects between adjacent distributed processing nodes. The higher-order aggregation network is configured of a higher-order aggregation node, and a higher-order communication path that connects between the higher-order aggregation node and 1st distributed processing nodes belonging to the lower-order aggregation networks. The distributed processing nodes belonging to the lower-order aggregation networks each generate distributed data for each of P (where P is an integer of 2 or greater) weights w[p] (p=1, . . . , P) of a neural network that is a learning target of an own node. The 1st distributed processing nodes belonging to the lower-order aggregation networks transmit distributed data generated at the own node to a 2nd distributed processing node belonging to a same lower-order aggregation network, as first aggregated data. Also, k′th (k=2, . . . , N[m]) distributed processing nodes belonging to the lower-order aggregation networks generate first aggregated data after updating, by finding a sum of first aggregated data received from a (k−1)′th distributed processing node belonging to the same lower-order aggregation network and distributed data generated by the own node for each corresponding weight w[p], and transmit this first aggregated data to a k⁺′th (where k⁺=k+1, except for where k=N[m], in which case k⁺=1) distributed processing node belonging to the same lower-order aggregation network. The 1st distributed processing nodes belonging to the lower-order aggregation networks transmit the first aggregated data received from an N[m]′th distributed processing node belonging to the same lower-order aggregation network to the higher-order aggregation node as second aggregated data. The higher-order aggregation node generates third aggregated data by finding the sum of the second aggregated data received from the 1st distributed processing nodes belonging to the lower-order aggregation networks for each corresponding weight w[p], and transmits this third aggregated data to the 1st distributed processing nodes belonging to the lower-order aggregation networks. The 1st distributed processing nodes belonging to the lower-order aggregation networks transmit the third aggregated data received from the higher-order aggregation node to the N[m]′th distributed processing node belonging to the same lower-order aggregation network. The k′th distributed processing nodes belonging to the lower-order aggregation networks transmit the third aggregated data received from the k⁺′th distributed processing nodes belonging to the same lower-order aggregation network to the (k−1)′th distributed processing node belonging to the same lower-order aggregation network. The 1st distributed processing nodes belonging to the lower-order aggregation networks receive the third aggregated data from the 2nd distributed processing node belonging to the same lower-order aggregation network. The distributed processing nodes update the weights w[p] of the neural networks on the basis of the third aggregated data that is received.

Also, a distributed processing system according to embodiments of the present invention includes M (where M is an integer of 2 or greater) lower-order aggregation networks and a higher-order aggregation network that connects between the M lower-order aggregation networks. The lower-order aggregation networks are configured of N[m] (m=1, . . . , M, where N[m] is an integer of 2 or greater) distributed processing nodes disposed in a ring form and a lower-order communication path that connects between adjacent distributed processing nodes. The higher-order aggregation network is configured of a higher-order communication path that connects between 1st distributed processing nodes belonging to the lower-order aggregation networks. The distributed processing nodes belonging to the lower-order aggregation networks each generate distributed data for each of P (where P is an integer of 2 or greater) weights w[p] (p=1, . . . , P) of a neural network that is a learning target of an own node. The 1st distributed processing nodes belonging to the lower-order aggregation networks transmit distributed data generated at the own node to a 2nd distributed processing node belonging to a same lower-order aggregation network, as first aggregated data. Also, k′th (k=2, . . . , N[m]) distributed processing nodes belonging to the lower-order aggregation networks generate first aggregated data after updating, by finding a sum of first aggregated data received from a (k−1)′th distributed processing node belonging to the same lower-order aggregation network and distributed data generated by the own node for each corresponding weight w[p], and transmit this first aggregated data to a k⁺′th (where k⁺=k+1, except for where k=N[m], in which case k⁺=1) distributed processing node belonging to the same lower-order aggregation network. The 1st distributed processing node belonging to a 1st lower-order aggregation network transmits the 1st aggregated data received from a N[1]′th distributed processing node belonging to the same lower-order aggregation network to the 1st distributed processing node belonging to a 2nd lower-order aggregation network, as second aggregated data. The 1st distributed processing node belonging to a j′th lower-order aggregation network (j=2, . . . , M) generates second aggregated data after updating, by finding a sum of second aggregated data received from the 1st distributed processing node belonging to a (j−1)′th lower-order aggregation network and first aggregated data received from an N[j]′th distributed processing node belonging to the same lower-order aggregation network, for each weight w[p], and transmits this second aggregated data to the 1st distributed processing node belonging to a j⁺′th (where j⁺=j+1, except for where j=M, in which case j⁺=1) lower-order aggregation network. The 1st distributed processing node belonging to the 1st lower-order aggregation network transmits the second aggregated data received from the 1st distributed processing node belonging to an M′th lower-order aggregation network to the 1st distributed processing node belonging to the M′th lower-order aggregation network as third aggregated data. The 1st distributed processing node belonging to the j′th lower-order aggregation network transmits the third aggregated data received from the 1st distributed processing node belonging to the j⁺′th lower-order aggregation network to the 1st distributed processing node belonging to the (j−1)′th lower-order aggregation network, and also transmits the third aggregated data to the N[j]'th distributed processing node belonging to the same lower-order aggregation network. The 1st distributed processing node belonging to the 1st lower-order aggregation network transmits the third aggregated data received from the 1st distributed processing node belonging to the second lower-order aggregation network to the N[1]′th distributed processing node belonging to the same lower-order aggregation network. The k′th distributed processing nodes belonging to the lower-order aggregation networks transmit the third aggregated data received from the k⁺′th distributed processing node belonging to the same lower-order aggregation network to the (k−1)′th distributed processing node belonging to the same lower-order aggregation network. The 1st distributed processing nodes belonging to the lower-order aggregation networks receive the third aggregated data from the 2nd distributed processing node belonging to the same lower-order aggregation network. The distributed processing nodes update the weights w[p] of the neural networks on the basis of the third aggregated data that is received.

Also, in one configuration example of the distributed processing system according to embodiments of the present invention, the 1st distributed processing node belonging to an m′th (m=1, . . . , M) lower-order aggregation network is provided with a first communication port that is capable of bidirectional communication at the same time with an n⁺′th (where n⁺=n+1, except for where n=N[m], in which case n⁺=1) distributed processing node belonging to the same lower-order aggregation network, a second communication port that is capable of bidirectional communication at the same time with an n⁻′th (where n⁻=n−1, except for where n=1, in which case n⁻=N[m]) distributed processing node belonging to the same lower-order aggregation network, and a third communication port that is capable of bidirectional communication at the same time with the higher-order aggregation node. A k′th distributed processing node belonging to the m′th lower-order aggregation network is provided with the first communication port and the second communication port. The higher-order aggregation node is provided with M fourth communication ports that are capable of bidirectional communication at the same time with the lower-order aggregation networks. The distributed processing nodes each include an in-node aggregation processing unit that generates the distributed data, a first transmission unit that transmits the first aggregated data from the first communication port of the own node to the 2nd distributed processing node belonging to the same lower-order aggregation network in a case where the own node functions as the 1st distributed processing node belonging to the lower-order aggregation networks, and that transmits the first aggregated data after updating from the first communication port of the own node to the k⁺′th distributed processing node belonging to the same lower-order aggregation network in a case where the own node functions as the k′th distributed processing node belonging to the lower-order aggregation networks, a first reception unit that receives the first aggregated data from the N[m]′th distributed processing node belonging to the same lower-order aggregation network via the second communication port of the own node, a second transmission unit that transmits the second aggregated data from the third communication port of the own node to the higher-order aggregation node in a case where the own node functions as the 1st distributed processing node belonging to the lower-order aggregation networks, a second reception unit that receives the third aggregated data from the higher-order aggregation node via the third communication port of the own node in a case where the own node functions as the 1st distributed processing node belonging to the lower-order aggregation networks, a third transmission unit that transmits the third aggregated data received from the higher-order aggregation node to the N[m]′th distributed processing node belonging to the same lower-order aggregation network via the second communication port of the own node in a case where the own node functions as the 1st distributed processing node belonging to the lower-order aggregation networks, and that transmits the third aggregated data received from the k⁺′th distributed processing node belonging to the same lower-order aggregation network to the (k−1)′th distributed processing node belonging to the same lower-order aggregation network via the second communication port of the own node in a case where the own node functions as the k′th distributed processing node belonging to the lower-order aggregation networks, a third reception unit that receives the third aggregated data from the 2nd distributed processing node belonging to the same lower-order aggregation network via the first communication port of the own node in a case where the own node functions as the 1st distributed processing node belonging to the lower-order aggregation networks, and that receives the third aggregated data from the k⁺′th distributed processing node belonging to the same lower-order aggregation network via the first communication port of the own node in a case where the own node functions as the k′th distributed processing node belonging to the lower-order aggregation networks, a first aggregated data generating unit that generates the first aggregated data after updating in a case where the own node functions as the k′th distributed processing node belonging to the lower-order aggregation networks, and a weight updating processing unit that updates the weight w[p] of the neural network on the basis of the third aggregated data that is received. The higher-order aggregation node includes a fourth reception unit that receives the second aggregated data from the 1st distributed processing nodes belonging to the lower-order aggregation networks via the fourth communication port of the own node, a second aggregated data generating unit that generates the third aggregated data by finding a sum of the second aggregated data received from the 1st distributed processing nodes belonging to the lower-order aggregation networks, for each corresponding weight w[p], and a fourth transmission unit that transmits the third aggregated data from the fourth communication port of the own node to the 1st distributed processing nodes belonging to the lower-order aggregation networks.

Also, in one configuration example of the distributed processing system according to embodiments of the present invention, the 1st distributed processing node belonging to an m′th (m=1, . . . , M) lower-order aggregation network is provided with a first communication port that is capable of bidirectional communication at the same time with an n⁺′th (where n⁺=n+1, except for where n=N[m], in which case n⁺=1) distributed processing node belonging to the same lower-order aggregation network, a second communication port that is capable of bidirectional communication at the same time with an n⁻′th (where n⁻=n−1, except for where n=1, in which case n⁻=N[m]) distributed processing node belonging to the same lower-order aggregation network, a third communication port that is capable of bidirectional communication at the same time with a 1st distributed processing node belonging to an m⁺′th (where m⁺=m+1, except for where m=M, in which case m⁺=1) lower-order aggregation network, and a fourth communication port that is capable of bidirectional communication at the same time with a 1st distributed processing node belonging to an m⁻′th (where m⁻=m−1, except for where m=1, in which case m⁻=M) lower-order aggregation network. A k′th distributed processing node belonging to the m′th lower-order aggregation network is provided with the first communication port and the second communication port. The distributed processing nodes each further include an in-node aggregation processing unit that generates the distributed data, a first transmission unit that transmits the first aggregated data from the first communication port of the own node to the 2nd distributed processing node belonging to the same lower-order aggregation network in a case where the own node functions as the 1st distributed processing node belonging to the lower-order aggregation networks, and that transmits the first aggregated data after updating from the first communication port of the own node to the k⁺′th distributed processing node belonging to the same lower-order aggregation network in a case where the own node functions as the k′th distributed processing node belonging to the lower-order aggregation networks, a first reception unit that receives the first aggregated data via the second communication port of the own node, a first aggregated data generating unit that generates the first aggregated data after updating in a case where the own node functions as the k′th distributed processing node belonging to the lower-order aggregation networks, a second transmission unit that transmits the first aggregated data received from the N[1]′th distributed processing node belonging to the same lower-order aggregation network to the 1st distributed processing node belonging to the 2nd lower-order aggregation network from the third communication port of the own node, as the second aggregated data, in a case where the own node functions as the 1st distributed processing node belonging to the 1st lower-order aggregation network, and that transmits the second aggregated data after updating to the 1st distributed processing node belonging to the j⁺′th lower-order aggregation network from the third communication port of the own node, in a case where the own node functions as the 1st distributed processing node belonging to the j′th lower-order aggregation network, a second reception unit that receives the second aggregated data via the fourth communication port of the own node in a case where the own node functions as the 1st distributed processing node belonging to the lower-order aggregation networks, a second aggregated data generating unit that generates the second aggregated data after updating in a case where the own node functions as the 1st distributed processing node belonging to the j′th lower-order aggregation network, a third transmission unit that transmits the second aggregated data received from the 1st distributed processing node belonging to the M′th lower-order aggregation network to the 1st distributed processing node belonging to the M′th lower-order aggregation network from the fourth communication port of the own node, as the third aggregated data, in a case where the own node functions as the 1st distributed processing node belonging to the 1st lower-order aggregation network, and that transmits the third aggregated data received from the 1st distributed processing node belonging to the j⁺′th lower-order aggregation network to the 1st distributed processing node belonging to the (j−1)′th lower-order aggregation network via the fourth communication port of the own node, in a case where the own node functions as the 1st distributed processing node belonging to the j′th lower-order aggregation network, a third reception unit that receives the third aggregated data via the third communication port of the own node in a case where the own node functions as the 1st distributed processing node belonging to the lower-order aggregation networks, a fourth transmission unit that transmits the third aggregated data received from the 1st distributed processing node belonging to the 2nd lower-order aggregation network to the N[1]′th distributed processing node belonging to the same lower-order aggregation networks from the second communication port of the own node in a case where the own node functions as the 1st distributed processing node belonging to the 1st lower-order aggregation network, that transmits the third aggregated data received from the 1st distributed processing node belonging to the j⁺′th lower-order aggregation network to the N[j]′th distributed processing node belonging to the same lower-order aggregation networks from the second communication port of the own node in a case where the own node functions as the 1st distributed processing node belonging to the j′th lower-order aggregation network, and that transmits the third aggregated data received from the k⁺′th distributed processing node belonging to the same lower-order aggregation network to the (k−1)′th distributed processing node belonging to the same lower-order aggregation networks from the second communication port of the own node in a case where the own node functions as the k′th distributed processing node belonging to the lower-order aggregation networks, a fourth reception unit that receives the third aggregated data from the 2nd distributed processing node belonging to the same lower-order aggregation network via the first communication port of the own node in a case where the own node functions as the 1st distributed processing node belonging to the lower-order aggregation networks, and a weight updating processing unit that updates the weight w[p] of the neural network on the basis of the third aggregated data that is received.

Also, embodiments of the present invention provide a distributed processing method in a system provided with a plurality of lower-order aggregation networks and a higher-order aggregation network that connects between the plurality of lower-order aggregation networks. Each of the lower-order aggregation networks includes at least a plurality of distributed processing nodes disposed in a ring form. The method includes a first step of the distributed processing nodes belonging to the lower-order aggregation networks each generating distributed data for each weight of a neural network that is a learning target of an own node, a second step of the lower-order aggregation networks aggregating, for each lower-order aggregation network, the distributed data generated by the distributed processing nodes belonging to the lower-order aggregation networks, a third step of the higher-order aggregation network generating aggregated data where the aggregation results of the lower-order aggregation networks are further aggregated, and distributing to the lower-order aggregation networks, a fourth step of the lower-order aggregation networks distributing the aggregated data distributed by the higher-order aggregation network to the distributed processing nodes belonging to a same lower-order aggregation network, and a fifth step of the distributed processing nodes belonging to the lower-order aggregation networks updating weights of the neural network on the basis of the distributed aggregated data.

Also, embodiments of the present invention provide a distributed processing method in a system provided with M (where M is an integer of 2 or greater) lower-order aggregation networks and a higher-order aggregation network that connects between the M lower-order aggregation networks. The lower-order aggregation networks are configured of N[m] (m=1, . . . , M, where N[m] is an integer of 2 or greater) distributed processing nodes disposed in a ring form and a lower-order communication path that connects between adjacent distributed processing nodes. The higher-order aggregation network is configured of a higher-order aggregation node and a higher-order communication path that connects between the higher-order aggregation node and 1st distributed processing nodes belonging to the lower-order aggregation networks. The method includes a first step of the distributed processing nodes belonging to the lower-order aggregation networks each generating distributed data for each of P (where P is an integer of 2 or greater) weights w[p] (p=1, . . . , P) of a neural network that is a learning target of an own node, a second step of the 1st distributed processing nodes belonging to the lower-order aggregation networks transmitting distributed data generated at the own node to a 2nd distributed processing node belonging to a same lower-order aggregation network, as first aggregated data, a third step of k′th (k=2, . . . , N[m]) distributed processing nodes belonging to the lower-order aggregation networks generating first aggregated data after updating, by finding a sum of first aggregated data received from a (k−1)′th distributed processing node belonging to the same lower-order aggregation network and distributed data generated by the own node for each corresponding weight w[p], and transmitting this first aggregated data to a k⁺′th (where k⁺=k+1, except for where k=N[m], in which case k⁺=1) distributed processing node belonging to the same lower-order aggregation network, a fourth step of the 1st distributed processing nodes belonging to the lower-order aggregation networks transmitting the first aggregated data received from an N[m]′th distributed processing node belonging to the same lower-order aggregation network to the higher-order aggregation node as second aggregated data, a fifth step of the higher-order aggregation node generating third aggregated data by finding the sum of the second aggregated data received from the 1st distributed processing nodes belonging to the lower-order aggregation networks for each corresponding weight w[p], and transmitting this third aggregated data to the 1st distributed processing nodes belonging to the lower-order aggregation networks, a sixth step of the 1st distributed processing nodes belonging to the lower-order aggregation networks transmitting the third aggregated data received from the higher-order aggregation node to the N[m]′th distributed processing node belonging to the same lower-order aggregation network, a seventh step of the k′th distributed processing nodes belonging to the lower-order aggregation networks transmitting the third aggregated data received from the k⁺′th distributed processing nodes belonging to the same lower-order aggregation network to the (k−1)′th distributed processing node belonging to the same lower-order aggregation network, an eighth step of the 1st distributed processing nodes belonging to the lower-order aggregation networks receiving the third aggregated data from the 2nd distributed processing node belonging to the same lower-order aggregation network, and a ninth step of the distributed processing nodes updating the weights w[p] of the neural networks on the basis of the third aggregated data that is received.

Also, embodiments of the present invention provide a distributed processing method in a system provided with M (where M is an integer of 2 or greater) lower-order aggregation networks and a higher-order aggregation network that connects between the M lower-order aggregation networks. The lower-order aggregation networks are configured of N[m] (m=1, . . . , M, where N[m] is an integer of 2 or greater) distributed processing nodes disposed in a ring form and a lower-order communication path that connects between adjacent distributed processing nodes. The higher-order aggregation network is configured of a higher-order communication path that connects between 1st distributed processing nodes belonging to the lower-order aggregation networks. The method includes a first step of the distributed processing nodes belonging to the lower-order aggregation networks each generating distributed data for each of P (where P is an integer of 2 or greater) weights w[p] (p=1, . . . , P) of a neural network that is a learning target of an own node, a second step of the 1st distributed processing nodes belonging to the lower-order aggregation networks transmitting distributed data generated at the own node to a 2nd distributed processing node belonging to a same lower-order aggregation network, as first aggregated data, a third step of k′th (k=2, . . . , N[m]) distributed processing nodes belonging to the lower-order aggregation networks generating first aggregated data after updating, by finding a sum of first aggregated data received from a (k−1)′th distributed processing node belonging to the same lower-order aggregation network and distributed data generated by the own node for each corresponding weight w[p], and transmitting this first aggregated data to a k⁺′th (where k⁺=k+1, except for where k=N[m], in which case k⁺=1) distributed processing node belonging to the same lower-order aggregation network, a fourth step of the 1st distributed processing node belonging to a 1st lower-order aggregation network transmitting the 1st aggregated data received from a N[1]′th distributed processing node belonging to the same lower-order aggregation network to the 1st distributed processing node belonging to a 2nd lower-order aggregation network, as second aggregated data, a fifth step of the 1st distributed processing node belonging to a j′th lower-order aggregation network (j=2, . . . , M) generating second aggregated data after updating, by finding a sum of second aggregated data received from the 1st distributed processing node belonging to a (j−1)′th lower-order aggregation network and first aggregated data received from an N[j]′th distributed processing node belonging to the same lower-order aggregation network, for each weight w[p], and transmitting this second aggregated data to the 1st distributed processing node belonging to a j⁺′th (where j⁺=j+1, except for where j=M, in which case j⁺=1) lower-order aggregation network, a sixth step of the 1st distributed processing node belonging to the 1st lower-order aggregation network transmitting the second aggregated data received from the 1st distributed processing node belonging to an M′th lower-order aggregation network to the 1st distributed processing node belonging to the M′th lower-order aggregation network as third aggregated data, a seventh step of the 1st distributed processing node belonging to the j′th lower-order aggregation network transmitting the third aggregated data received from the 1st distributed processing node belonging to the j⁺′th lower-order aggregation network to the 1st distributed processing node belonging to the (j−1)′th lower-order aggregation network, and also transmitting the third aggregated data to the N[j]′th distributed processing node belonging to the same lower-order aggregation network, an eighth step of the 1st distributed processing node belonging to the 1st lower-order aggregation network transmitting the third aggregated data received from the 1st distributed processing node belonging to the second lower-order aggregation network to the N[1]′th distributed processing node belonging to the same lower-order aggregation network, a ninth step of the k′th distributed processing nodes belonging to the lower-order aggregation networks transmitting the third aggregated data received from the k⁺′th distributed processing node belonging to the same lower-order aggregation network to the (k−1)′th distributed processing node belonging to the same lower-order aggregation network, a tenth step of the 1st distributed processing nodes belonging to the lower-order aggregation networks receiving the third aggregated data from the 2nd distributed processing node belonging to the same lower-order aggregation network, and an eleventh step of the distributed processing nodes updating the weights w[p] of the neural networks on the basis of the third aggregated data that is received.

### Effects of Embodiments of the Invention

According to embodiments of the present invention, the lower-order aggregation networks aggregate distributed data generated by the distributed processing nodes belonging to the lower-order aggregation networks for each lower-order aggregation network, the higher-order aggregation network generates aggregated data where the aggregation results of the lower-order aggregation networks are further aggregated and distributes this data to the lower-order aggregation networks, and the lower-order aggregation networks distribute the aggregated data distributed by the higher-order aggregation network to the distributed processing nodes belonging to the same lower-order aggregation network, whereby time necessary for distributed processing can be reduced, and effects of reduced processing speed due to increase in the number of distributed processing nodes can be suppressed.

Also, in embodiments of the present invention, lower-order aggregation communication processing where an n′th (n=1, . . . , N[m]) distributed processing node transmits first aggregated data to an n⁺′th (where n⁺=n+1, except for where n=N[m], in which case n⁺=1) distributed processing node in the lower-order aggregation networks, lower-order inter-node aggregation processing where first aggregated data after updating is calculated on the basis of the first aggregated data received by a k′th (k=2, . . . , N[m]) distributed processing node and distributed data generated at the own node in the lower-order aggregation networks, and lower-order distribution communication processing where the n′th distributed processing node transmits third aggregated data to an n⁻′th (where n⁻=n−1, except for where n=1, in which case n⁻=N[m]) distributed processing node in the lower-order aggregation networks, can be performed in parallel at approximately the same time. Accordingly, effective distributed processing can be performed, and learning efficiency of the neural network can be improved. In embodiments of the present invention, each distributed processing node is provided with a first communication port and a second communication port, and the directions of lower-order aggregation communication and lower-order distribution communication are reversed, and accordingly, starting the lower-order distribution communication does not need to wait until lower-order aggregation communication is completed.

### BRIEF DESCRIPTION OF THE DRAWINGS

FIG. 1 is a block diagram illustrating a configuration example of a deep learning distributed processing system according to a first embodiment of the present invention.

FIG. 2 is a block diagram illustrating a configuration example of a distributed processing node in the deep learning distributed processing system according to the first embodiment of the present invention.

FIG. 3 is a block diagram illustrating a configuration example of a distributed processing node in the deep learning distributed processing system according to the first embodiment of the present invention.

FIG. 4 is a block diagram illustrating a configuration example of a higher-order aggregation node in the deep learning distributed processing system according to the first embodiment of the present invention.

FIG. 5 is a flowchart for describing sample data inputting processing, gradient calculation processing, and in-node aggregation processing, of the distributed processing node according to the first embodiment of the present invention.

FIG. 6 is a flowchart for describing lower-order aggregation communication processing, lower-order inter-node aggregation processing, higher-order aggregation communication processing, higher-order node aggregation processing, higher-order distribution communication processing, and lower-order distribution communication processing, of a lower-order aggregation network and a higher-order aggregation network according to the first embodiment of the present invention.

FIG. 7 is a flowchart for describing weight updating processing of the distributed processing node according to the first embodiment of the present invention.

FIG. 8 is a block diagram illustrating a configuration example of a deep learning distributed processing system according to a second embodiment of the present invention.

FIG. 9 is a block diagram illustrating a configuration example of a distributed processing node in the deep learning distributed processing system according to the second embodiment of the present invention.

FIG. 10 is a block diagram illustrating a configuration example of a distributed processing node in the deep learning distributed processing system according to the second embodiment of the present invention.

FIG. 11 is a flowchart for describing lower-order aggregation communication processing, lower-order inter-node aggregation processing, higher-order aggregation communication processing, higher-order node aggregation processing, higher-order distribution communication processing, and lower-order distribution communication processing, of a lower-order aggregation network and a higher-order aggregation network according to the second embodiment of the present invention.

FIG. 12 is a flowchart for describing lower-order aggregation communication processing, lower-order inter-node aggregation processing, higher-order aggregation communication processing, higher-order node aggregation processing, higher-order distribution communication processing, and lower-order distribution communication processing, of the lower-order aggregation network and the higher-order aggregation network according to the second embodiment of the present invention.

FIG. 13 is a block diagram illustrating a configuration example of a computer that realizes the distributed processing nodes and the higher-order aggregation nodes according to the first and second embodiments of the present invention.

FIG. 14 is a diagram illustrating a relation between the number of distributed processing nodes and processing performance of deep learning in a conventional distributed processing system.

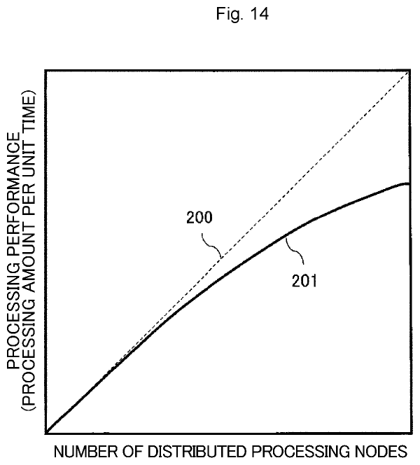

### DETAILED DESCRIPTION OF ILLUSTRATIVE EMBODIMENTS

### First Embodiment

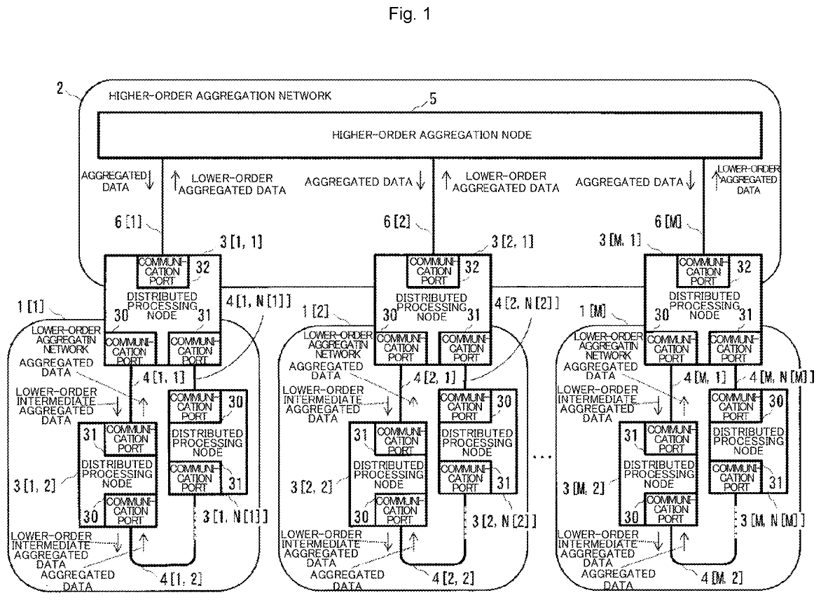

Embodiments of the present invention will be described below with reference to the drawings. FIG. 1 is a block diagram illustrating a configuration example of a deep learning distributed processing system according to a first embodiment of the present invention. The distributed processing system in FIG. 1 is provided with M (where M is an integer of 2 or greater) lower-order aggregation networks 1[m] (m=1, . . . , M) each of which includes a plurality of distributed processing nodes, and a higher-order aggregation network 2 that connects between the M lower-order aggregation networks 1[m].

The lower-order aggregation networks 1[m] (m=1, . . . , M) are configured of N[m] (where N[m] is an integer of 2 or greater) distributed processing nodes 3[m, n] (n=1, . . . , N[m]) and lower-order communication paths 4[m, n] (n=1, . . . , N[m]) , which will be described next. The lower-order communication paths 4[m, n] are provided for bidirectional communication between the distributed processing nodes 3[m, n] (n=1, . . . , N[m]) of No. n and the distributed processing nodes 3[n⁺] of the next No. n⁺ (where n⁺=n+1, except for where n=N[m], in which case n⁺=1). Note that relay processing nodes that relay communication may be optionally interposed on optional lower-order communication paths 4[m, n] (n=1, . . . , N[m]), besides transmission paths. Also, the number N[m] of distributed processing nodes may be a number that is different from at least part of the lower-order aggregation networks 1[m], or may be the same as the number of the lower-order aggregation networks 1[m].

The lower-order aggregation networks 1[m] (m=1, . . . , M) aggregate distributed data generated by the distributed processing nodes 3[m, n] belonging to lower-order aggregation networks 1[m], and generate lower-order aggregated data Ru[p, m] (p=1, . . . , P). The higher-order aggregation network 2 aggregates the lower-order aggregated data Ru[p, m] to generate aggregated data R[p], and distributes the aggregated data R[p] to the lower-order aggregation networks 1[m] (m=1, . . . , M). The lower-order aggregation networks 1[m] (m=1, . . . , M) distribute the aggregated data R[p] distributed by the higher-order aggregation network 2 to the distributed processing nodes 3[m, n] belonging to the lower-order aggregation networks 1[m].

The higher-order aggregation network 2 is made up of a higher-order aggregation node 5, and higher-order communication paths 6[m] provided for bidirectional communication of the higher-order aggregation node 5 with distributed processing nodes 3[m, 1] belonging to the lower-order aggregation network 1[m] (m=1, . . . , M). Note that relay processing nodes that relay communication may be optionally interposed on optional higher-order communication paths 6[m] (m=1, . . . , M), besides transmission paths.

The distributed processing nodes 3[m, n] (n=1, . . . , N[m]) each have a communication port 30 and a communication port 31 that are capable of bidirectional communication at the same time. The communication ports 30 are communication ports for the distributed processing nodes 3[m, n] to perform bidirectional communication with the distributed processing nodes 3[m, n⁺] (where n⁺=n+1, except for where n=N[m], in which case n⁺=1). The communication ports 30 are connected to the lower-order communication paths 4[m, n]. Also, the communication ports 31 are communication ports for the distributed processing nodes 3[m, n] to perform bidirectional communication with distributed processing nodes 3[m, n⁻] (where n⁻=n−1, except for where n=1, in which case n⁻=N[m]). The communication ports 31 are connected to lower-order communication paths 4[m, n⁻].

The distributed processing nodes 3[m, 1] (m=1, . . . , M) further each have a communication port 32 capable of bidirectional communication at the same time. The communication ports 32 are communication ports for the distributed processing nodes 3[m, 1] to perform bidirectional communication with the higher-order aggregation node 5, and are connected to the higher-order communication paths 6[m].

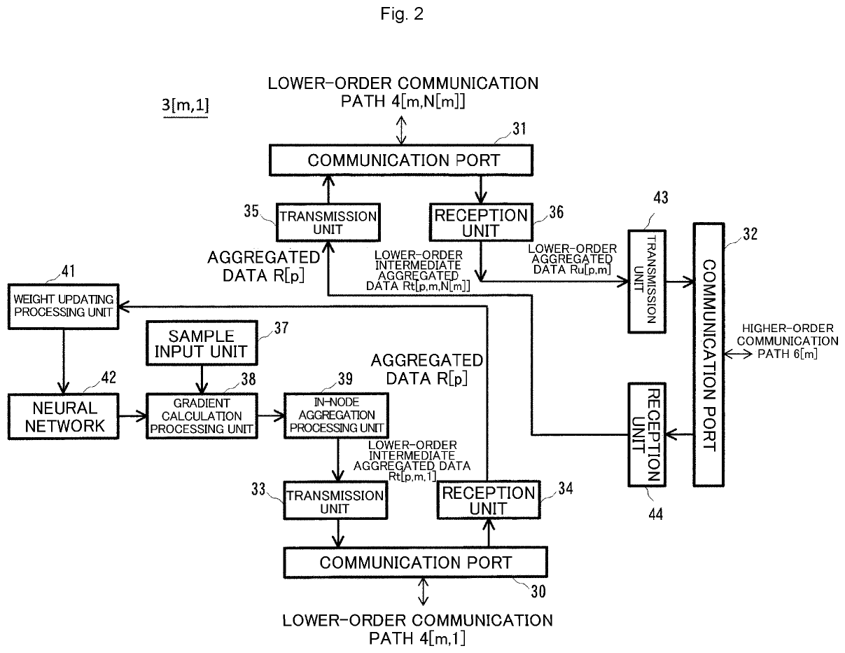

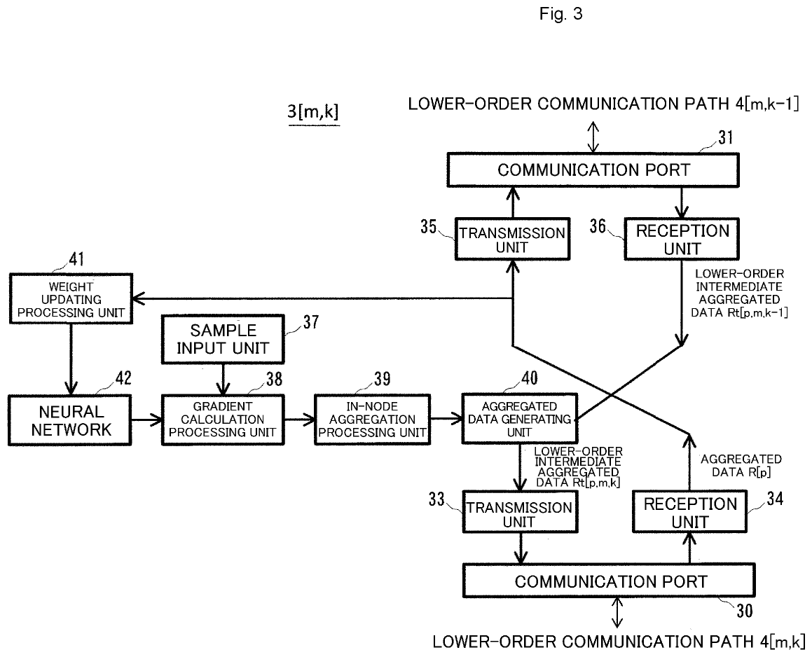

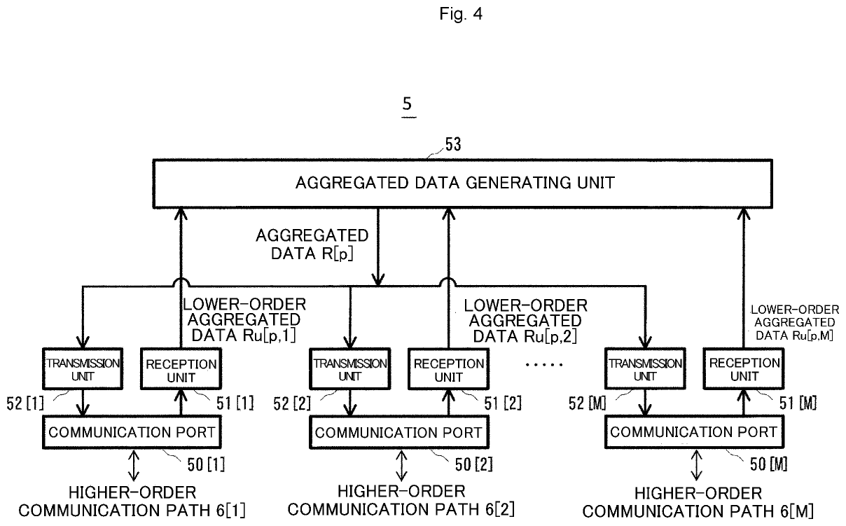

FIG. 2 is a block diagram illustrating a configuration example of the distributed processing node 3[m, 1] (m=1, . . . , M) according to the present embodiment. FIG. 3 is a block diagram illustrating a configuration example of a distributed processing node 3[m, k] (k=2, . . . , N[m]) according to the present embodiment. FIG. 4 is a block diagram illustrating a configuration example of the higher-order aggregation node 5.

The distributed processing node 3[m, 1] is provided with the communication port 30 (first communication port), the communication port 31 (second communication port), the communication port 32 (third communication port), a transmission unit 33 (first transmission unit), a reception unit 34 (third reception unit), a reception unit 36 (first reception unit), a sample input unit 37, a gradient calculation processing unit 38, an in-node aggregation processing unit 39, a weight updating processing unit 41, a neural network 42 that is a mathematical model constructed on the basis of software, a transmission unit 43 (second transmission unit), and a reception unit 44 (second reception unit).

The distributed processing node 3[m, k] (k=2, . . . , N[m]) is provided with the communication port 30 (first communication port), the communication port 31 (second communication port), the transmission unit 33 (first transmission unit), the reception unit 34 (third reception unit), a transmission unit 35 (third transmission unit), the reception unit 36 (first reception unit), the sample input unit 37, the gradient calculation processing unit 38, the in-node aggregation processing unit 39, an aggregated data generating unit 40 (first aggregated data generating unit), the weight updating processing unit 41, and the neural network 42.

The higher-order aggregation node 5 is provided with communication ports 50[m] (fourth communication port), reception units 51[m] (fourth reception unit), transmission units 52[m] (fourth transmission unit), and an aggregated data generating unit 53 (second aggregated data generating unit).

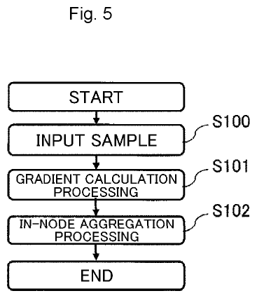

FIG. 5 is a flowchart for describing sample data inputting processing, gradient calculation processing, and in-node aggregation processing, of the distributed processing nodes 3[m, n] (m=1, . . . , M, n=1, . . . , N[m]).

The sample input units 37 of the distributed processing nodes 3[m, n] input S (where S is an integer of 2 or greater) pieces of sample data x[m, n, s] (s=1, . . . , S) that are each different, from a data collection node omitted from illustration, for each mini-batch (step S100 in FIG. 5).

Note that the present invention is not limited to a sample data collection method by the data collection mode, nor to a method of assigning the collected sample data to N sets and distributing to the distributed processing nodes 3[m, n], and is applicable irrespective of these methods.

When sample data x[m, n, s] is input, the gradient calculation processing units 38 of the distributed processing nodes 3[m, n] (m=1, . . . , M, n=1, . . . , N[m]) calculate, with regard to each of P (where P is an integer of 2 or greater) weights w[p] (p=1, . . . , P) of the neural network 42 that is the learning target of the own node, a gradient G[p, m, n, s] of a loss function of the neural network 42, for each sample data x[m, n, s] (step S101 in FIG. 5).

The method of constructing the neural networks 42 at the distributed processing nodes 3[m, n] by software, the weight w[p] of the neural networks 42, the loss function that is an indicator indicating the poorness of performance of the neural networks 42, and the gradient G[p, m, n, s] of the loss function are known technologies, and accordingly detailed description will be omitted.

Next, the in-node aggregation processing unit 39 of each of the distributed processing nodes 3[m, n] (m=1, . . . , M, n=1, . . . , N[m]) generates and stores distributed data D[p, m, n] that is numerical values obtained by aggregating the gradient G[p, m, n, s] of each sample data, for each weight w[p] (step S102 in FIG. 5). The expression for calculating the distributed data D[p, m, n] is as follows.

Expression 1

D[p, m, n]=Σ_{s=1, . . . ,S} G[p, m, n, s] (1)

Note that the gradient calculation processing in step S101 and the in-node aggregation processing in step S102 can be pipelined in increments of sample data. This pipelining refers to performing gradient calculation processing on certain sample data, and at the same time performing in-node aggregation processing of aggregating gradients acquired from sample data one prior thereto at the same time.

Further, after the distributed data D[p, m, n] is generated by the distributed processing nodes 3[m, n] (m=1, . . . , M, n=1, . . . , N[m]), the distributed processing nodes [m, 1] acquire lower-order aggregated data Ru[p, m] by communication with the distributed processing nodes 3[m, n] (n=1, . . . , N[m]) belonging to the same lower-order aggregation networks 1[m], and computation at each of the nodes. The process of the distributed processing nodes [m, 1] acquiring the lower-order aggregated data Ru[p, m] for each lower-order aggregation network 1[m] (m=1, . . . , M) will be described below.

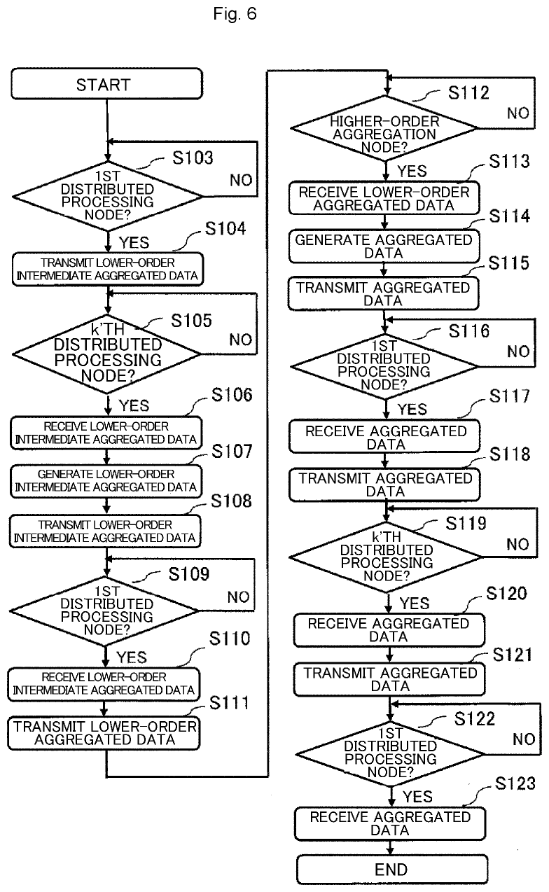

FIG. 6 is a flowchart for describing lower-order aggregation communication processing, lower-order inter-node aggregation processing, higher-order aggregation communication processing, higher-order node aggregation processing, higher-order distribution communication processing, and lower-order distribution communication processing, of the lower-order aggregation networks 1[m] and the higher-order aggregation network 2.

In the present embodiment, the lower-order aggregation communication processing is processing where, in the lower-order aggregation networks 1[m] (m=1, . . . , M), the n′th (n=1, . . . , N[m]) distributed processing nodes 3[m, n] transmit lower-order intermediate aggregated data (first aggregated data) to the n⁺′th distributed processing nodes 3[m, n⁺]. Note that n⁺=n+1, except for where n=N[m], in which case n⁺=1. The lower-order inter-node aggregation processing is processing where, in the lower-order aggregation networks 1[m] (m=1, . . . , M), the k′th (k=2, . . . , N[m]) distributed processing nodes 3a[m, k] perform processing of calculating lower-order intermediate aggregated data after updating, on the basis of lower-order intermediate aggregated data received thereby, and distributed data generated at the own nodes thereof. The higher-order aggregation communication processing is processing of the 1st distributed processing nodes 3[m, 1] of the lower-order aggregation networks 1[m] (m=1, . . . , M) transmitting lower-order aggregated data (second aggregated data) to the higher-order aggregation node 5.

Also, higher-order node aggregation processing is processing of the higher-order aggregation node 5 finding the sum of the lower-order aggregated data to generate aggregated data (third aggregated data). The higher-order distribution communication processing is processing of the higher-order aggregation node 5 transmitting aggregated data to the 1st distributed processing nodes 3[m, 1] of the lower-order aggregation networks 1[m] (m=1, . . . , M). The lower-order distribution communication processing is processing where, in the lower-order aggregation networks 1[m] (m=1, . . . , M), the n′th (n=1, . . . , N[m]) distributed processing nodes transmit aggregated data to the n⁻′th (where n⁻=n−1, except for where n=1, in which case n⁻=N[m]) distributed processing nodes.

The transmission units 33 of the 1st distributed processing nodes 3[m, 1] belonging to the lower-order aggregation networks 1[m] (m=1, . . . , M) and that have been set in advance transmit, to the next-numbered distributed processing nodes 3[m, 2] belonging to the same lower-order aggregation networks 1[m], P pieces of distributed data D[p, m, 1] (p=1, . . . , P) generated by the in-node aggregation processing units 39 of the own nodes (steps S103, S104 in FIG. 6). Note that this distributed data D[p, m, 1] is transmitted via the communication ports 30 of the own nodes and the lower-order communication paths 4[m, 1] a as lower-order intermediate aggregated data Rt[p, m, 1]. That is to say, the lower-order intermediate aggregated data Rt[p, m, 1] at this time is the same as the distributed data D[p, m, 1].

Expression 2

Rt[p, m, 1]=D[p, m, 1] (2)

Next, the reception unit 36 of the k′th distributed processing nodes 3[m, k] (k=2, . . . , N[m]), excluding the 1st, belonging to the lower-order aggregation networks 1[m] (m=1, . . . , M), receives lower-order intermediate aggregated data Rt[p, m, k−1] from the preceding-numbered distributed processing nodes 3[m, k−1] belonging to the same lower-order aggregation networks 1[m], via the communication ports 31 of the own nodes and the lower-order communication paths 4[m, k−1] (steps S105, S106 in FIG. 6).

The aggregated data generating unit 40 of the distributed processing nodes 3[m, k] (m=1, . . . , M, k=2, . . . , N[m]) generate lower-order intermediate aggregated data Rt[p, m, k] in the order of the No. p, as described below (step S107 in FIG. 6). Here, the sum of the lower-order intermediate aggregated data Rt[p, m, k−1] received by the reception units 36 of the own nodes and the distributed data D[p, m, k] generated by the in-node aggregation processing units 39 of the own nodes is found for each corresponding weight w[p] (each No. p). That is to say, the lower-order intermediate aggregated data Rt[p, m, k] is configured of P numerical values. The expression for calculating the lower-order intermediate aggregated data Rt[p, m, k] is as follows.

Expression 3

Rt[p, m, k]=Rt[p, m, k−1]+D[p, m, k] (3)

The transmission units 33 of the distributed processing nodes 3[m, k] (m=1, . . . , M, k=2, . . . , N[m]) transmit the P pieces of lower-order intermediate aggregated data Rt[p, m, k] (p=1, . . . , P) generated by the aggregated data generating units 40 of the own nodes to the next-numbered distributed processing nodes 3[m, k⁺] belonging to the same lower-order aggregation networks 1[m], via the communication ports 30 of the own nodes and the lower-order communication paths 4[m, k] (step S108 in FIG. 6). Note that k⁺=k+1, except for where k=N[m], in which case k⁺=1.

Thus, the lower-order intermediate aggregated data Rt[p, m, N[m]] (p=1, . . . , P) configured of P numerical values calculated by Expression 2 and Expression 3 is calculated on the basis of the distributed data D[p, m, n] (m=1, . . . , M) configured of P numerical values generated at the distributed processing nodes 3[m, n] (n=1, . . . , N[m]). The values of the lower-order intermediate aggregated data Rt[p, m, N[m]] can be expressed by the following expression.

Expression 4

Rt[p, m, N[m]]Σ_{n=1, . . . ,N[m]} D[p, m, n] (4)

Next, the lower-order intermediate aggregated data Rt[p, m, N[m]] is distributed to the distributed processing nodes 3[m, n] (m=1, . . . , M, n=1, . . . , N[m]) belonging to the same lower-order aggregation networks 1[m], as lower-order aggregated data. This is lower-order distribution communication.

The reception unit 36 of the 1st distributed processing nodes 3[m, 1] belonging to the lower-order aggregation networks 1[m] (m=1, . . . , M) receives the lower-order intermediate aggregated data Rt[p, m, N[m]] from the N[m]′th distributed processing nodes 3[m, N[m]] belonging to the same lower-order aggregation networks 1[m], via the communication ports 31 of the own nodes and the lower-order communication paths 4[m, N[m]] (steps S109, S110 in FIG. 6).

The transmission unit 43 of the 1st distributed processing node 3[m, 1] transmits the lower-order intermediate aggregated data Rt[p, m, N[m]] received by the reception units 36 of the own nodes to the higher-order aggregation node 5 as lower-order aggregated data Ru[p, m], via the communication ports 32 of the own nodes and the higher-order communication paths 6[m] (step S111 in FIG. 6). The lower-order aggregated data Ru[p, m] (p=1, . . . , P) is the same as the lower-order intermediate aggregated data Rt[p, m, N[m]], and is configured of P numerical values.

Expression 5

Ru[p, m]=Rt[p, m, N[m]]=Σ_{n=1, . . . ,N[m]} D[p, m, n] (5)

The lower-order aggregation networks 1[m] (m=1, . . . , M) each acquire respective lower-order aggregated data Ru[p, m]. This processing is performed independently from a process of other lower-order aggregation networks 1[m′] (m′=1, . . . , M, m′≠m) acquiring lower-order aggregated data Ru[p, m′]. That is to say, the lower-order aggregation networks 1[m] (m=1, . . . , M) are capable of performing the lower-order aggregation communication processing, the lower-order inter-node aggregation processing, and the higher-order aggregation communication processing, in parallel with the same processing being performed at the other lower-order aggregation networks 1[m′] (m′=1, . . . , M, m′≠m).

Next, the reception units 51[m] (m=1, . . . , M) of the higher-order aggregation node 5 of the higher-order aggregation network 2 receive the lower-order aggregated data Ru[p, m] from each of the distributed processing nodes 3[m, 1], via the higher-order communication paths 6[m] and the communication ports 50[m] of the own nodes (steps S112, S113 in FIG. 6).

The aggregated data generating unit 53 of the higher-order aggregation node 5 finds the sum of the lower-order aggregated data Ru[p, m] (p=1, . . . , P) received by the reception units 51[m] (m=1, . . . , M) of the own nodes for each weight w[p] (each No. p), thereby generating aggregated data R[p] in the order of No. p (step S114 in FIG. 5). That is to say, the aggregated data R[p] is configured of P numerical values. The expression for calculating the aggregated data R[p] is as follows.

Expression 6

R[p]=Σ_{m=1, . . . ,M} Ru[p, m]=Σ_{m=1, . . . ,M} Σ_{n=1, . . . ,N[m]} D[p, m, n] (6)

Thus, the aggregated data R[p] is, with regard to all distributed processing nodes 3[m, n] (m=1, . . . , M, n=1, . . . , N[m]) in the distributed processing system, the results of aggregating the distributed data D[p, m, n] generated by these distributed processing nodes.

The transmission units 52[m] (m=1, . . . , M) of the higher-order aggregation node 5 transmit the P pieces of aggregated data R[p] (p=1, . . . , P) generated by the aggregated data generating unit 53 of the own node to the 1st distributed processing nodes 3[m, 1] belonging to the corresponding lower-order aggregation networks 1[m] (m=1, . . . , M) via the communication ports 50[m] of the own nodes and the higher-order communication paths 6[m] (step S115 in FIG. 6).

Next, the reception units 44 of the first distributed processing nodes 3[m, 1] belonging to the lower-order aggregation networks 1[m] (m=1, . . . , M) receive the aggregated data R[p] (p=1, . . . , P) from the higher-order aggregation node 5, via the higher-order communication paths 6[m] and the communication port 32 of the own node (steps S116, S117 in FIG. 6).

The transmission units 35 of the distributed processing nodes 3[m, 1] (m=1, . . . , M) then transmit the aggregated data R[p] (p=1, . . . , P) received by the reception units 44 of the own nodes to the N[m]′th distributed processing nodes 3[m, N[m]] belonging to the same lower-order aggregation networks 1[m], via the communication ports 31 of the own nodes and the lower-order communication paths 4[m, N[m]] (step S118 in FIG. 6).

The reception units 34 of the k′th distributed processing nodes 3[m, k] (k=N[m], . . . , 2), excluding the 1st, belonging to the lower-order aggregation networks 1[m] (m=1, . . . , M) receive the aggregated data R[p] (p=1, . . . , P) from the next-numbered distributed processing nodes 3[m, k⁺] (where k⁺=k+1, except for where k=N[m], in which case k⁺=1), belonging to the same lower-order aggregation networks 1[m], via the lower-order communication paths 4[m, k] and the communication ports 30 of the own nodes (steps S119, S120 in FIG. 6).

The transmission units 35 of the distributed processing nodes 3[m, k] (k=N[m], . . . , 2) transmit the aggregated data R[p] (p=1, . . . , P) received by the reception units 34 of the own nodes, to the preceding-numbered distributed processing nodes 3[m, k−1] belonging to the same lower-order aggregation networks 1[m], via the communication ports 31 of the own nodes and the lower-order communication path 4[m, k−1] (step S121 in FIG. 6).

The reception units 34 of the 1st distributed processing nodes 3[m, 1] (m=1, . . . , M) belonging to the lower-order aggregation networks 1[m] (m=1, . . . , M) receive aggregated data R[p] (p=1, . . . , P) from the 2nd distributed processing nodes 3[m, 2] belonging to the same lower-order aggregation networks 1[m], via the lower-order communication paths 4[m, 1] and the communication ports 30 of the own nodes (steps S122, S123 in FIG. 6).

According to the above higher-order distribution communication and lower-order distribution communication, all distributed processing nodes 3[m, n] (m=1, . . . , M, n=1, . . . , N[m]) can acquire the same aggregated data R[p].

The higher-order aggregation network 2 distributes the aggregated data R[p] to the lower-order aggregation networks 1[m] (m=1, . . . , M) , and further each of the lower-order aggregation networks 1[m] distributes the aggregated data R[p] to the distributed processing nodes 3[m, n] (n=1, . . . , N[m]) belonging to the lower-order aggregation networks 1[m]. Such higher-order distribution communication and lower-order distribution communication are performed independently from other lower-order aggregation networks 1[m′] (m′=1, . . . , M, m′≠m). That is to say, the lower-order aggregation networks 1[m] (m=1, . . . , M) are capable of performing the higher-order distribution communication and the lower-order distribution communication in parallel with the same processing being performed at other lower-order aggregation networks 1[m′] (m′=1, . . . , M, m′≠m).

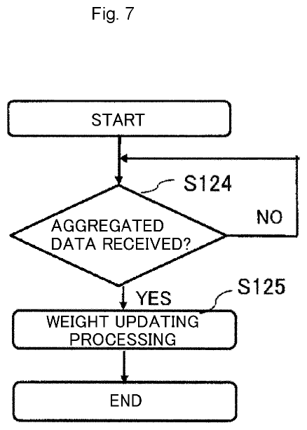

FIG. 7 is a flowchart for describing weight updating processing of the distributed processing nodes 3[m, n] (m=1, . . . , M, n=1, . . . , N[m]). Upon aggregated data R[p] (p=1, . . . , P) being received by the reception units 34 of the own nodes (YES in step S124 in FIG. 7), the weight updating processing units 41 of the distributed processing nodes 3[m, n] perform weight updating processing of updating the weights w[p] of the neural networks 42 of the own nodes on the basis of the received aggregated data R[p] (step S125 in FIG. 7). In the weight updating processing, it is sufficient to update the weight w[p] for each No. p so that the loss function is smallest, on the basis of the gradient of the loss function indicated by the aggregated data R[p]. Updating of the weights w[p] is a known technology, and accordingly detailed description will be omitted.

In this way, the weight updating processing is processing of updating the weights w[p] on the basis of the aggregated data R[p] acquired in the order of No. p of the weights w[p]. Accordingly, the distributed processing nodes 3[m, n] (m=1, . . . , M, n=1, . . . , N[m]) can perform weight updating processing for the weights w[p] in the order of No. p.

Ending of the weight updating processing ends one set of mini-batch learning, and the distributed processing nodes 3[m, n] (m=1, . . . , M, n=1, . . . , N[m]) continue and perform processing of the next mini-batch learning on the basis of the updated weight w[p]. That is to say, the distributed processing nodes 3[m, n] receive sample data for the next mini-batch learning from a data collection node omitted from illustration, and repeat the processing of the mini-batch learning described above, thereby improving the inference accuracy of the neural networks of the own nodes.

As shown in the present embodiment, the lower-order aggregation networks 1[m] (m=1, . . . , M) can perform the lower-order aggregation communication processing of acquiring the lower-order aggregated data Ru[p, m], the lower-order inter-node aggregation processing, and the higher-order aggregation communication processing, in parallel with the same processing being performed at other lower-order aggregation networks 1[m′] (m′=1, . . . , M, m′≠m). Also, the lower-order aggregation networks 1[m] (m=1, . . . , M) can perform the higher-order distribution communication and the lower-order distribution communication of distributing the aggregated data R[p] in parallel with the same processing being performed at other lower-order aggregation networks 1[m′] (m′=1, . . . , M, m′≠m).

When compared with a distributed processing system where all distributed processing nodes belong to a single lower-order aggregation network, aggregation communication processing, aggregation processing, and distribution communication processing are processed in parallel by the lower-order aggregation networks 1[m] (m=1, . . . , M) in the distributed processing system according to the present embodiment, and accordingly time required for such processing can be reduced, and effects of higher speed due to distributed processing can be maintained even in a case where the number of distributed processing nodes increases.

For example, in the distributed processing system according to the present embodiment, with the number of lower-order aggregation networks 1[m] as M, the number of distributed processing nodes 3[m, n] belonging to each lower-order aggregation networks 1[m] as N[m]=N, and delay time that occurs at one distributed processing node for aggregation communication processing or distribution communication processing as Td, the delay time T2 required for aggregation communication processing and distribution communication processing is as in the following expression.

Expression 7

T2=2×Td+2×N×Td (7)

Here, the delay of the higher-order aggregation node 5 is also written as Td. The first term in Expression 7 represents the sum of the delay Td of the higher-order aggregation node 5 and the delay Td of each of the distributed processing nodes 3[m, 1] connected to the higher-order aggregation node 5 exchanging data with the higher-order aggregation node 5. Also, the second term of Expression 7 represents the sum of the delay (N×Td) for data to make one round through the distributed processing nodes 3[m, n] within each lower-order aggregation network 1[m] to generate the lower-order aggregated data Ru[p, m], and the delay (N×Td) of data making one round through the distributed processing nodes 3[m, n] within each lower-order aggregation networks 1[m] to distribute the aggregated data R[p].

Conversely, in a distributed processing system accommodating M×N distributed processing nodes under one lower-order aggregation network, instead of performing parallel processing under M lower-order aggregation networks 1[m] as in the present embodiment, the time T2 required for aggregation communication processing and distribution communication processing is as in the following expression.

Expression 8

T2=2×M×N×Td (8)

Note that the delay of the higher-order aggregation node is not included in Expression 8, since there is no need to provide a higher-order aggregation node in a distributed processing system accommodating M×N distributed processing nodes under one lower-order aggregation network.

The time that the aggregation processing takes is a value where the above delay time T2 is added to the time T1 from each node starting acquiring aggregated data until completion thereof (time from reception of the start to reception of the end of aggregated data) (=T1+T2), and the smaller this value is, the shorter the amount of time till completion of aggregation processing (overhead for distributed processing) is. Generally, the number of nodes (M×N) is a value that is greater than one, and accordingly, the distributed processing system according to the present embodiment where the nodes are arranged in parallel in M lower-order aggregation networks 1[m] has an excellent advantage in that the effects of reduced speed due to increase in the number of distributed processing nodes can be suppressed to 1/M of that of a distributed processing system configured of one aggregation network.

### Second Embodiment

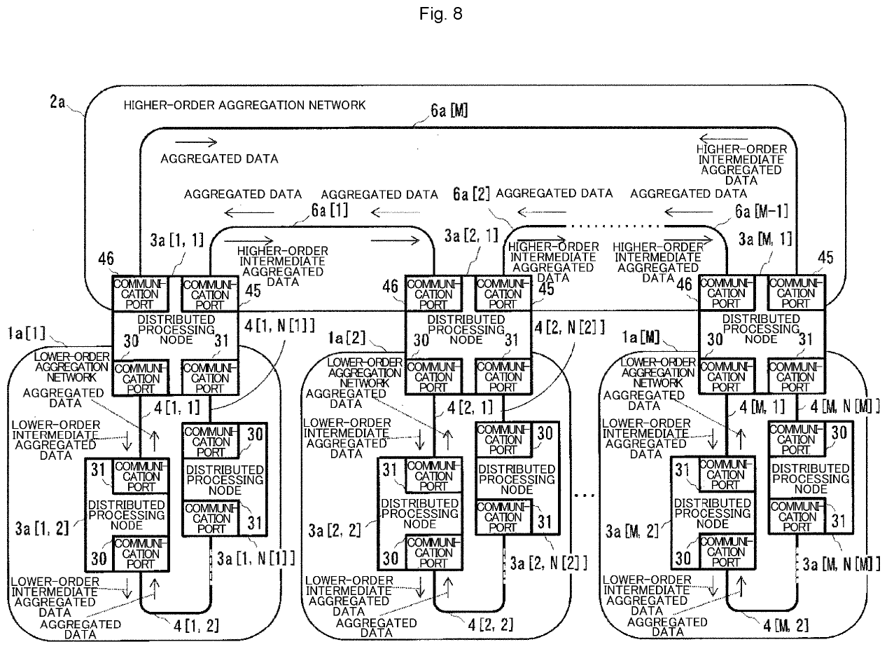

Next, a second embodiment of the present invention will be described. FIG. 8 is a block diagram illustrating a configuration example of a deep learning distributed processing system according to the second embodiment of the present invention. The distributed processing system in FIG. 8 is provided with M (where M is an integer of 2 or greater) lower-order aggregation networks 1a[m] (m=1, . . . , M) each of which includes a plurality of distributed processing nodes, and a higher-order aggregation network 2a that connects between the M lower-order aggregation networks 1a[m].

The lower-order aggregation networks 1a[m] (m=1, . . . , M) are configured of N[m] (where N[m] is an integer of 2 or greater) distributed processing nodes 3a[m, n] (n=1, . . . , N[m]) and lower-order communication paths 4[m, n] (n=1, . . . , N[m]). The lower-order communication paths 4[m, n] here are provided for bidirectional communication between the distributed processing nodes 3a[m, n] (n=1, . . . , N[m]) of No. n and the distributed processing nodes 3a[n⁺] of the next No. n⁺ (where n⁺=n+1, except for where n=N[m], in which case n⁺=1).

The lower-order aggregation networks 1a[m] (m=1, . . . , M) aggregate distributed data generated by the distributed processing nodes 3a[m, n] belonging to lower-order aggregation networks 1a[m], and generate lower-order aggregated data Ru[p, m] (p=1, . . . , P). The higher-order aggregation network 2a aggregates the lower-order aggregated data Ru[p, m] to generate aggregated data R[p], and distributes the aggregated data R[p] to the lower-order aggregation networks 1a[m] (m=1, . . . , M). The lower-order aggregation networks 1a[m] (m=1, . . . , M) distribute the aggregated data R[p] distributed by the higher-order aggregation network 2 to the distributed processing nodes 3a[m, n] belonging to the lower-order aggregation networks 1a[m].

The higher-order aggregation network 2a is made up of higher-order communication paths 6a[m] for bidirectional communication between the distributed processing nodes 3a[m, 1] belonging to the lower-order aggregation networks 1a[m] (m=1, . . . , M) and the distributed processing nodes 3a[m⁺, 1] of the next No. m⁺ (where m⁺=m+1, except for where m=M, in which case m⁺=1) belonging to lower-order aggregation networks 1a[m′]. Note that relay processing nodes that relay communication may be optionally interposed on optional higher-order communication paths 6a[m] (m=1, . . . , M), besides transmission paths.

The distributed processing nodes 3a[m, n] (n=1, . . . , N[m]) each have a communication port 30 and a communication port 31 that are capable of bidirectional communication at the same time, in the same way as with the first embodiment.

Further, the distributed processing nodes 3a[m, 1] (m=1, . . . , M) are each provided with a communication port 45 and a communication port 46 capable of bidirectional communication at the same time. The communication port 45 is a communication port for bidirectional communication by the distributed processing nodes 3a[m, 1] belonging to the lower-order aggregation networks 1a[m] (m=1, . . . , M) with the distributed processing nodes 3a[m⁺, 1] of the next No. m⁺ (where m⁺=m+1, except for where m=M, in which case m⁺=1) belonging to the lower-order aggregation networks 1a[m⁺], and is connected to the higher-order communication paths 6[m]. The communication port 46 is a communication port for bidirectional communication by the distributed processing nodes 3a[m, 1] belonging to the lower-order aggregation networks 1a[m] (m=1, . . . , M) with the distributed processing nodes 3a[m⁻, 1] of the No. m⁻ (where m⁻=m−1, except for where m=1, in which case m⁻=M) belonging to the lower-order aggregation networks 1a[m⁻], and is connected to the higher-order communication paths 6[m⁻].

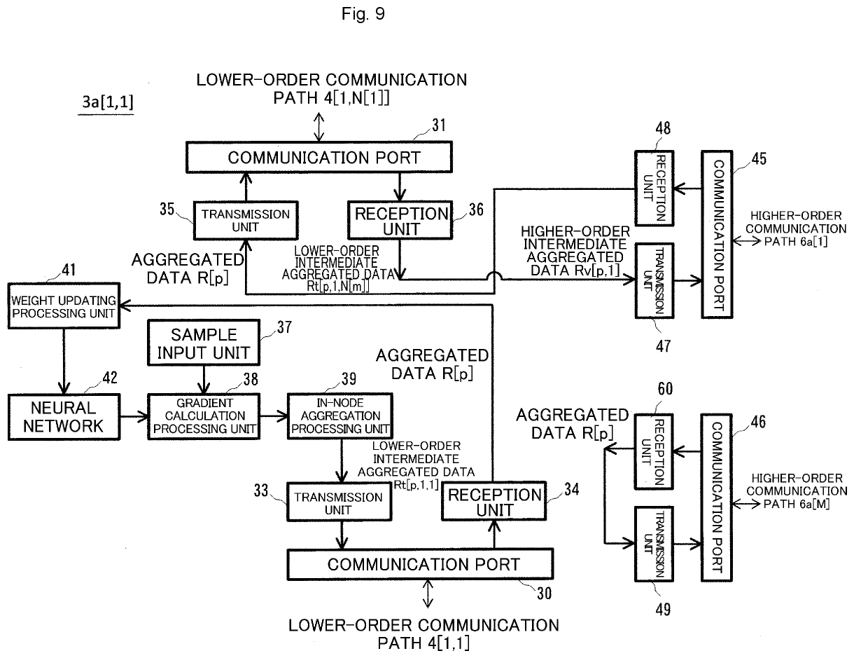

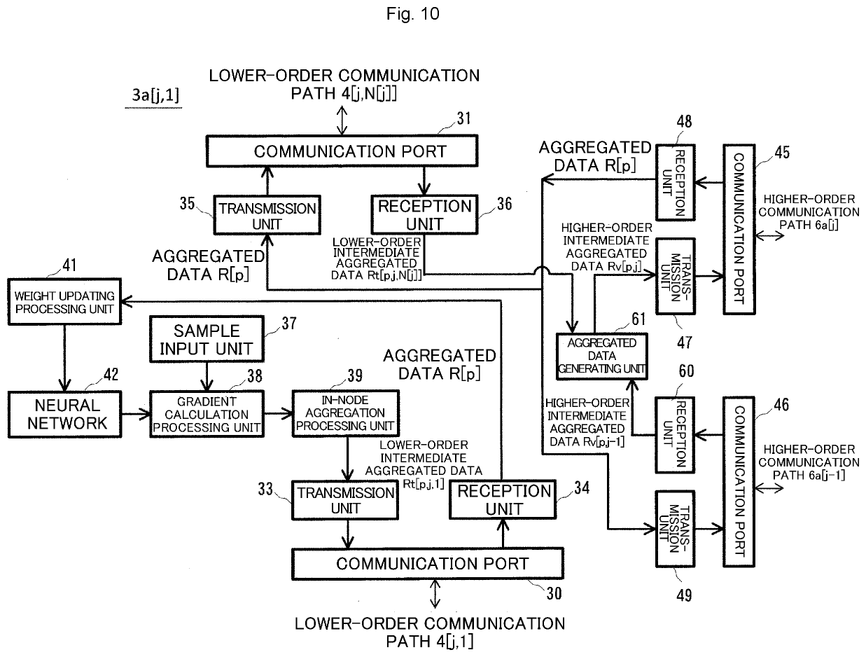

FIG. 9 is a block diagram illustrating a configuration example of a distributed processing node 3a[1, 1] according to the present embodiment. FIG. 10 is a block diagram illustrating a configuration example of a distributed processing node 3a[j, 1] (j=2, . . . , M) according to the present embodiment.

The distributed processing node 3a[1, 1] is provided with the communication port 30 (first communication port), the communication port 31 (second communication port), the transmission unit 33 (first transmission unit), the reception unit 34 (fourth reception unit), the transmission unit 35 (fourth transmission unit), the reception unit 36 (first reception unit), the sample input unit 37, the gradient calculation processing unit 38, the in-node aggregation processing unit 39, the weight updating processing unit 41, the neural network 42, the communication port 45 (third communication port), the communication port 46 (fourth communication port), a transmission unit 47 (second transmission unit), a reception unit 48 (third reception unit), a transmission unit 49 (third transmission unit), and a reception unit 60 (second reception unit).

The distributed processing node 3a[j, 1] (j=2, . . . , M) is provided with the communication port 30 (first communication port), the communication port 31 (second communication port), the transmission unit 33 (first transmission unit), the reception unit 34 (fourth reception unit), the transmission unit 35 (fourth transmission unit), the reception unit 36 (first reception unit), the sample input unit 37, the gradient calculation processing unit 38, the in-node aggregation processing unit 39, the weight updating processing unit 41, the neural network 42, the communication port 45 (third communication port), the communication port 46 (fourth communication port), the transmission unit 47 (second transmission unit), the reception unit 48 (third reception unit), the transmission unit 49 (third transmission unit), the reception unit 60 (second reception unit), and an aggregated data generating unit 61 (second aggregated data generating unit).

The configuration of the distributed processing nodes 3a[m, k] (m=1, . . . , M, k=2, . . . , N[m]) is the same as that of the distributed processing nodes 3[m, k] in the first embodiment. That is to say, the distributed processing node 3a[m, k] is provided with the communication port 30 (first communication port), the communication port 31 (second communication port), the transmission unit 33 (first transmission unit), the reception unit 34 (fourth reception unit), the transmission unit 35 (fourth transmission unit), the reception unit 36 (first reception unit), the sample input unit 37, the gradient calculation processing unit 38, the in-node aggregation processing unit 39, the aggregated data generating unit 40 (first aggregated data generating unit), the weight updating processing unit 41, and the neural network 42.

The sample data inputting processing, the gradient calculating processing, and the inter-node aggregation processing of the distributed processing nodes 3a[m, n] (m=1, . . . , M, n =1, . . . , N[m]) is the same as that described by way of FIG. 5 in the first embodiment.

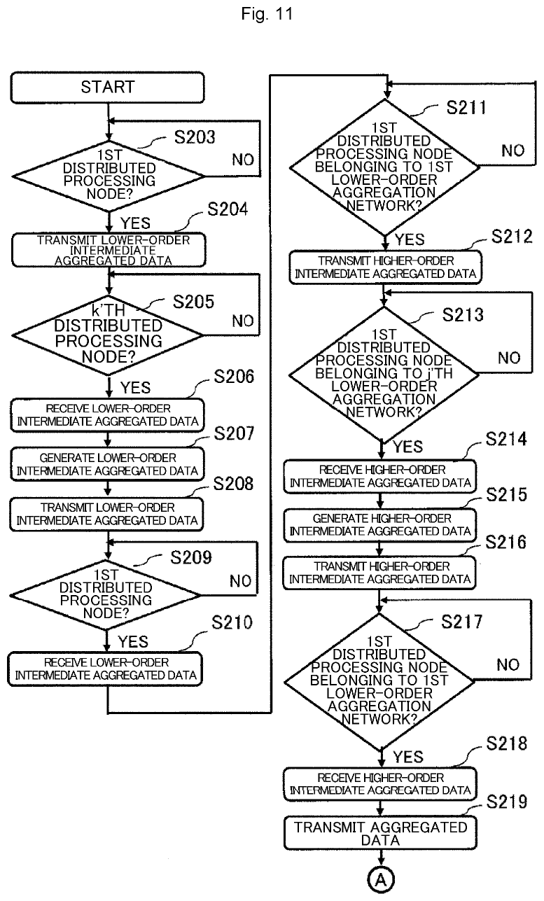

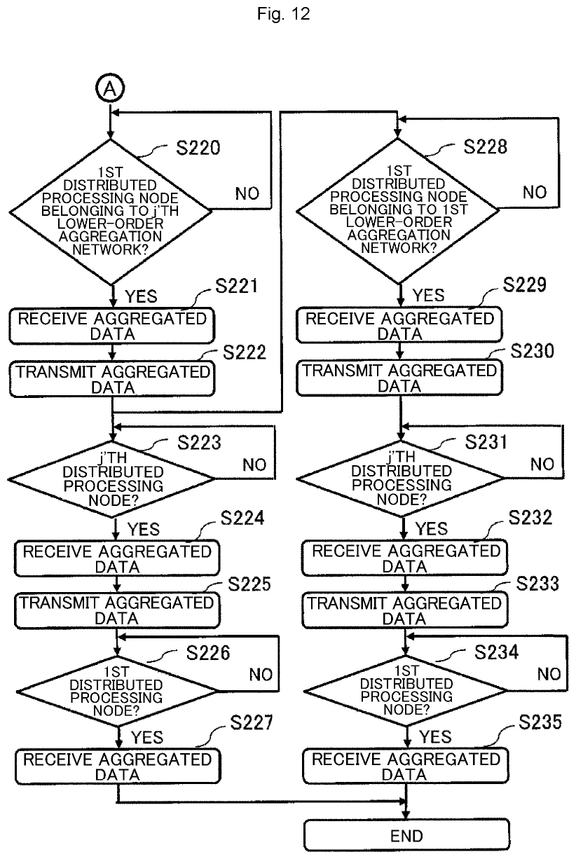

FIG. 11 and FIG. 12 are a flowchart for describing lower-order aggregation communication processing, lower-order inter-node aggregation processing, higher-order aggregation communication processing, higher-order node aggregation processing, higher-order distribution communication processing, and lower-order distribution communication processing, of the lower-order aggregation networks 1a[m] and the higher-order aggregation network 2a.

The lower-order aggregation communication processing, the lower-order inter-node aggregation processing, and the lower-order distribution communication processing are the same as in the first embodiment. In the present embodiment, the higher-order aggregation communication processing is processing of the 1st distributed processing nodes 3a[m, 1] belonging to the m′th lower-order aggregation network 1a[m] (m=1, . . . , M) transmitting higher-order intermediate aggregated data (second aggregated data) to the distributed processing nodes 3a[m⁺, 1] belonging to the m⁺′th (where m⁺=m+1, except for where m=M, in which case m⁺=1) lower-order aggregation network 1a[m⁺]. The higher-order node aggregation processing is processing of the 1st distributed processing nodes 3a[j, 1] belonging to the j′th lower-order aggregation network 1a[j] (j=2, . . . , M) calculating higher-order intermediate aggregated data after updating, on the basis of higher-order intermediate aggregated data that has been received, and lower-order intermediate aggregated data that has been received. The higher-order distribution communication processing is processing of the 1st distributed processing nodes 3a[m, 1] belonging to the m′th lower-order aggregation network 1a[m] transmitting aggregated data (third aggregated data) to the distributed processing nodes 3a[m⁻, 1] belonging to the m⁻′th (where m⁻=m−1, except for where m=1, in which case m⁻=M) lower-order aggregation network 1a[m⁻].

The lower-order aggregation communication processing and lower-order inter-node aggregation processing at the lower-order aggregation networks 1a[m] (m=1, . . . , M) is the processing shown in steps S203 through S208 in FIG. 11, which is the same as the processing of steps S103 through S108 in FIG. 6 in the first embodiment described above, and accordingly description will be omitted.

The reception units 36 of the 1st distributed processing nodes 3a[m, 1] belonging to the lower-order aggregation networks 1a[m] (m=1, . . . , M) receive the lower-order intermediate aggregated data Rt[p, m, N[m]] (p=1, . . . , P) from the N[m]′th distributed processing nodes 3a[m, N[m]] belonging to the same lower-order aggregation networks 1a[m], via the communication ports 31 of the own nodes and the lower-order communication paths 4[m, N[m]] (steps S209, S210 in FIG. 11).

Next, the transmission unit 47 of the 1st distributed processing node 3a[1,1] belonging to the 1st lower-order aggregation network 1a[1] that has been set in advance transmits the lower-order intermediate aggregated data Rt[p, 1, N[1]] (p=1, . . . , P) received by the reception unit 36 of the own node to the 1st distributed processing node 3a[2, 1] belonging to the 2nd lower-order aggregation network 1a[2] (steps S211, S212 in FIG. 11). Now, the aforementioned lower-order intermediate aggregated data Rt[p, 1, N[1]] is transmitted via the communication port 45 of the own node and the higher-order communication path 6a[1], as higher order intermediate aggregated data Rv[p, 1]. The higher-order intermediate aggregated data Rv[p, 1] is the same as the lower-order intermediate aggregated data Rt[p, 1, N[m]] (the lower-order aggregated data Ru[p, 1] in the first embodiment), and is configured of P numerical values.

Expression 9

Rv[p, 1]=Rt[p, 1, N[m]]=Ru[p, 1] (9)

Next, the reception unit 60 of the 1st distributed processing node 3a[j, 1] belonging to the j′th lower-order aggregation network 1a[j] (j=2, . . . , M), excluding the 1st, receives the higher-order intermediate aggregated data Rv[p, j−1] from the 1st distributed processing node 3a[j−1, 1] belonging to the (j−1)′th lower-order aggregation network 1a[j−1], via the higher-order communication path 6a[j−1] and the communication port 46 of the own node (steps S213, S214 in FIG. 11).

The aggregated data generating unit 61 of the 1st distributed processing node 3a[j, 1] belonging to the j′th lower-order aggregation network 1a[j] (j=2, . . . , M) generates the higher-order intermediate aggregated data Rv[p, j] in the order of the No. p as described below (step S215 in FIG. 11). Now, the sum of the higher-order intermediate aggregated data Rv[p, j−1] (p=1, . . . , P) received by the reception unit 60 of the own node and the lower-order intermediate aggregated data Rt[p, j, N[j]] received by the reception unit 36 of the own node are found for each weight w[p] (each No. p). That is to say, the higher-order intermediate aggregated data Rv[p, j] is configured of P numerical values. The expression for calculating the higher-order intermediate aggregated data Rv[p, j] is as follows.

$$\begin{matrix} Expression 10 & \\ Rv [ p , j ] = Rv [ p , j \text{-} 1 ] + Rt [ p , j , N [ j ] ] = Rv [ p , j \text{-} 1 ] + Ru [ p , j ] & ( 10 )\end{matrix}$$

The transmission unit 47 of the distributed processing node 3a[j, 1] (j=2, . . . , M) then transmits the higher-order intermediate aggregated data Rv[p, j] (p=1, . . . , P) generated by the aggregated data generating unit 61 of the own node to the 1st distributed processing nodes 3a[j⁺, 1] belonging to the next No. j⁺ (where j⁺=j+1, except for where j=M, in which case j⁺=1) lower-order aggregation network 1a[j⁺], via the communication port 45 of the own node and the higher-order communication path 6a[j] (step S216 in FIG. 11).

In this way, the higher-order intermediate aggregated data Rv[p, M] (p=1, . . . , P), configured of P numerical values and calculated by Expression 9 and Expression 10, is calculated on the basis of the lower-order intermediate aggregated data Rt[p, m, N[m]] (=Ru[p, m]) configured of P numerical values acquired by each of the distributed processing nodes 3a[m, 1] (m=1, . . . , M). The values of the higher-order intermediate aggregated data Rv[p, M] can be expressed by the following expression.

Expression 11

Rv[p, M]=Σ_{m=1, . . . ,M} Rt[p, m, N[m]]=Σ_{m=1, . . . ,M} Ru[p, m] (11)

The reception unit 60 of the 1st distributed processing node 3a[1, 1] belonging to the 1st lower-order aggregation network 1a[1] receives the higher-order intermediate aggregated data Rv[p, M] (p=1, . . . , P) from the 1st distributed processing node 3a[M, 1] belonging to the M′th lower-order aggregation network 1a[M], via the higher-order communication path 6a[M] and the communication port 46 of the own node (steps S217, S218 in FIG. 12).

The transmission unit 49 of the distributed processing node 3a[1,1] then transmits the higher-order intermediate aggregated data Rv[p, M] (p=1, . . . , P) received by the reception unit 60 of the own node to the 1st distributed processing node 3a[M, 1] belonging to the M′th lower-order aggregation network 1a[M] (step S219 in FIG. 12). Now, the above-described higher-order intermediate aggregated data Rv[p, M] has been transmitted via the communication port 46 of the own node and the higher-order communication path 6a[M] as aggregated data R[p]. That is to say, the distributed processing node 3a[1,1] returns the higher-order intermediate aggregated data Rv[p, M] from the distributed processing node 3a[M, 1] to the distributed processing node 3a[M, 1] as aggregated data R[p]. The aggregated data R[p] is the same as the higher-order intermediate aggregated data Rv[p, M].

Expression 12

R[p]=Rv[p, M]=Σ_{m=1, . . . ,M} Rt[p, m, N[m]]=Σ_{m=1, . . . ,M} Ru[p, m] (12)

The lower-order aggregated data Ru[p, m] (p=1, . . . , P) is values generated at the lower-order aggregation networks 1[m] in the first embodiment, and is the values shown in Expression 5 in the first embodiment. Accordingly, the aggregated data R[p] can be expressed by the following expression.

Expression 13

R[p]=Σ_{m=1, . . . ,M} Ru[p, m]=Σ_{m=1, . . . ,M} Σ_{n=1, . . . ,N[m]} D[p, m, n] (13)

Thus, the aggregated data R[p] is the results of aggregating the distributed data D[p, m, n] generated regarding all distributed processing nodes 3a[m, n] (m=1, . . . , M, n=1, . . . , N[m]) within the distributed processing system, by these distributed processing nodes.

The reception unit 48 of the 1st distributed processing node 3a[j, 1] belonging to the j′th lower-order aggregation network 1a[j] (j=M, . . . , 2), excluding the 1st, receives the aggregated data R[p] from the 1st distributed processing node 3a[j⁺, 1] belonging to the j⁺′th (where j⁺=j+1, except for where j=M, in which case j⁺=1) lower-order aggregation network 1a[j⁺], via the higher-order communication path 6a[j] and the communication port 45 of the own node (steps S220, S221 in FIG. 12).

The transmission unit 49 of the distributed processing nodes 3a[j, 1] transmits the aggregated data R[p] (p=1, . . . , P) received by the reception unit 48 of the own node to the 1st distributed processing node 3a[j−1, 1] belonging to the (j−1)′th lower-order aggregation network 1a[j−1], via the communication port 46 of the own node and the higher-order communication path 6a[j−1] (step S222 in FIG. 12). At the same time, the transmission unit 35 of the distributed processing node 3a[j, 1] transmits the aggregated data R[p] received by the reception unit 48 of the own node to the N[j]′th distributed processing node 3[j, N[j]] belonging to the same lower-order aggregation network 1[j], via the communication port 31 of the own node and the lower-order communication path 4[j, N[j]] (step S222).

The processing shown in steps S223 through S227 is performed at the lower-order aggregation networks 1a[j] (j=M, . . . , 2). These steps S223 through S227 are the same as the processing of steps S119 through S123 described in FIG. 6, and accordingly description will be omitted.

Next, the reception unit 48 of the 1st distributed processing node 3a[1, 1] belonging to the 1st lower-order aggregation network 1a[1] receives the aggregated data R[p] from the 1st distributed processing node 3a[2, 1] belonging to the 2nd lower-order aggregation network 1a[2], via the higher-order communication path 6a[1] and the communication port 45 of the own node (steps S228, S229 in FIG. 12).

The transmission unit 35 of the distributed processing node 3a[1, 1] then transmits the aggregated data R[p] received by the reception unit 48 of the own node to the N[1]′th distributed processing node 3[1, N[1]] belonging to the same lower-order aggregation network 1[1], via the communication port 31 of the own node and the lower-order communication path 4[1, N[1]] (step S230 in FIG. 12).

The processing shown in steps S231 through S235 is performed at the lower-order aggregation network 1a[1]. These steps S231 through S235 are the same as the processing of steps S119 through S123 described in FIG. 6, and accordingly description will be omitted.

According to the above-described higher-order distribution communication and the lower-order distribution communication, all distributed processing nodes 3a[m, n] (m=1, . . . , M, n=1, . . . , N[m]) can acquire the same aggregated data R[p].

The aggregated data R[p] is distributed to the distributed processing nodes 3a[m, n] (n=1, . . . , N[m]) belonging to the lower-order aggregation networks 1a[m], for each lower-order aggregation network 1a[m] (m=1, . . . , M). Now, this lower-order distribution communication is performed independently from other lower-order aggregation networks 1a[m′] (m′=1, . . . , M, m′≠m). That is to say, each lower-order aggregation network 1a[m] (m=1, . . . , M) can perform lower-order distribution communication in parallel with the same processing being performed at other lower-order aggregation networks 1a[m′] (m′=1, . . . , M, m′≠m).

In the same way as in the first embodiment, upon the aggregated data R[p] (p=1, . . . , P) being received by the reception units 34 of the own nodes (YES in step S124 in FIG. 7), the weight updating processing units 41 of the distributed processing nodes 3a[m, n] (m=1, . . . , M, n=1, . . . , N[m]) perform weight updating processing of updating the weights w[p] of the neural networks 42 of the own nodes, on the basis of the aggregated data R[p] (step S125 in FIG. 7).

Ending of the weight updating processing ends one set of mini-batch learning, and the distributed processing nodes 3a[m, n] (m=1, . . . , M, n=1, . . . , N[m]) continue and perform processing of the next mini-batch learning, on the basis of the updated weight w[p]. That is to say, the distributed processing nodes 3a[m, n] receive sample data for the next mini-batch learning from a data collection node omitted from illustration, and repeat the processing of the mini-batch learning described above, thereby improving the inference accuracy of the neural networks of the own nodes.

As shown in the present embodiment, the lower-order aggregation networks 1a[m] (m=1, . . . , M) can perform the lower-order aggregation communication processing of acquiring the lower-order intermediate aggregated data Rt[p, m, N[m]] (=Ru[p, m]) and lower-order) inter-node aggregation processing in parallel with the same processing being performed at other lower-order aggregation networks 1a[m′] (m′=1, . . . , M, m′≠m). Also, the lower-order aggregation networks 1a[m] (m=1, . . . , M) can perform the lower-order distribution communication of distributing the aggregated data R[p] in parallel with the same processing being performed at other lower-order aggregation networks 1a[m′] (m′=1, . . . , M, m′≠m).

When compared with a distributed processing system where all distributed processing nodes belong to a single lower-order aggregation network, aggregation communication processing, aggregation processing, and distribution communication processing are processed in parallel by the lower-order aggregation networks 1a[m] (m=1, . . . , M) in the present embodiment, and accordingly time required for such processing can be reduced, and effects of higher speed due to distributed processing can be maintained even in a case where the number of distributed processing nodes increases.

For example, in the distributed processing system according to the present embodiment, with the number of lower-order aggregation networks 1a[m] as M, the number of distributed processing nodes 3a[m, n] belonging to each lower-order aggregation networks 1a[m] as N[m]=N, and the delay time that occurs at one distributed processing node for aggregation communication processing or distribution communication processing as Td, the delay time T2 required for aggregation communication processing and distribution communication processing is as in the following expression.

Expression 14

T2=2×M×Td+2×N×Td (14)

The first term in Expression 14 is the delay of aggregation and distribution at the higher-order aggregation network 2a, and the second term in Expression 14 is the delay of aggregation and distribution at each lower-order aggregation network 1a[m].

Conversely, in a distributed processing system accommodating M×N distributed processing nodes under one lower-order aggregation network, instead of performing parallel processing under M lower-order aggregation networks 1a[m] as in the present embodiment, the time T2 required for aggregation communication processing and distribution communication processing is as in Expression 8.

The time that the aggregation processing takes is a value where the above delay time T2 is added to the time T1 from each node starting acquiring aggregated data until completion thereof (time from reception of the start to reception of the end of aggregated data) (=T1+T2), and the smaller this value is, the shorter the amount of time till completion of aggregation processing (overhead for distributed processing) is. The values of M and N are both no less than 2, and accordingly (M×N)≥(M+N) holds. Accordingly, the distributed processing system according to the present embodiment where M lower-order aggregation networks 1a[m] are in parallel can suppress the effects of reduced speed due to increase in the number of distributed processing nodes as compared to a system configured of one aggregation network. The present embodiment particularly exhibits excellent advantages in a distributed processing system where (M×N)>>(M+N), where (M>>2, N>>2).

Note that in comparison with the first embodiment, the present embodiment has smaller effects of suppressing the effects of reduced speed due to increase in the number of distributed processing nodes. However, the first embodiment needs the communication ports 50[m] for connecting to the lower-order aggregation networks 1[m] (m=1, . . . , M), and the reception units 51[m] and the transmission units 52[m] and the aggregated data generating unit 53 for aggregating the data received at the communication ports 50[m] and distributing to the lower-order aggregation networks 1[m], to be provided to the higher-order aggregation node 5. Accordingly, when expanding the scale of the system by increasing the number M of lower-order aggregation networks 1[m], the higher-order aggregation node 5 needs to be replaced with an arrangement that can connect to a greater number of lower-order aggregation networks 1[m]. Conversely, this can be handled simply by adding additional lower-order aggregation networks to the existing distributed processing system in the present embodiment, thereby exhibiting a feature in that change in system scale is easy.

Description has been made in the present embodiment regarding a two-tiered system configured of M lower-order aggregation networks 1a[m] (m=1, . . . , M) and one higher-order aggregation network 2a that connects these. However, a large-scale distributed processing system that can suppress increase in time for aggregation processing due to increase in the number of distributed processing nodes can be constructed by providing a plurality of higher-order aggregation networks 2a, and also providing a further higher-order aggregation network for connecting these.

The distributed processing nodes 3[m, n] and 3a[m, n] (m=1, . . . , M, n=1, . . . , N[m]), and the higher-order aggregation node 5, described in the first and second embodiments, can each be realized by a computer provided with a CPU (Central Processing Unit), a storage device, and an interface, and a program for controlling these hardware resources.

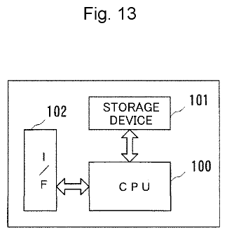

FIG. 13 illustrates a configuration example of this computer. The computer is provided with a CPU 100, a storage device 101, and an interface device (hereinafter abbreviated to I/F) 102. In the case of the distributed processing nodes 3[m, n] and 3a[m, n], communication circuits including, for example, the communication ports 30, 31, 32, 45, and 46 are connected to the I/F 102. Also, in the case of the higher-order aggregation node 5, communication circuits including, for example, the communication ports 50[m] are connected to the I/F 102. The CPU 100 of the nodes executes processing described in the first and second embodiments following the program stored in the storage device 101, and realizes the distributed processing system and the distributed processing method according to embodiments of the present invention.

### INDUSTRIAL APPLICABILITY

Embodiments of the present invention can be applied to technology that performs machine learning of a neural network.

### Reference Signs List

1, 1a Lower-order aggregation network
2, 2a Higher-order aggregation network
3, 3a Distributed processing node
4 Lower-order communication path
5 Higher-order aggregation node
6, 6a Higher-order communication path
30, 31, 32, 45, 46, 50 Communication port
33, 35, 43, 47, 49, 52 Transmission unit
34, 36, 44, 48, 51, 60 Reception unit
37 Sample input unit
38 Gradient calculation processing unit
39 In-node aggregation processing unit
40, 53, 61 Aggregated data generating unit
41 Weight updating processing unit
42 Neural network

1.-8. (canceled)

9. A distributed processing system, comprising:
a plurality of lower-order aggregation networks; and
a higher-order aggregation network that connects between the plurality of lower-order aggregation networks, each of the lower-order aggregation networks including a plurality of distributed processing nodes disposed in a ring form;
wherein the distributed processing nodes belonging to the lower-order aggregation networks are each configured to generate distributed data for each weight of a neural network that is a learning target of an own node;
wherein the lower-order aggregation networks are configured to aggregate, for each lower-order aggregation network, the distributed data generated by the distributed processing nodes belonging to the lower-order aggregation networks;
wherein the higher-order aggregation network is configured to generate aggregated data where the aggregation results of the lower-order aggregation networks are further aggregated and to distribute to the lower-order aggregation networks;
wherein the lower-order aggregation networks are configured to distribute the aggregated data distributed by the higher-order aggregation network to the distributed processing nodes belonging to a same lower-order aggregation network; and
wherein the distributed processing nodes belonging to the lower-order aggregation networks are configured to update weights of the neural network based on the distributed aggregated data.

10. A distributed processing system, comprising:
M lower-order aggregation networks, wherein M is an integer of 2 or greater, wherein the lower-order aggregation networks comprise:
N[m] (m=1, . . . , M) distributed processing nodes disposed in a ring form, wherein wherein N[m] is an integer of 2 or greater; and
a lower-order communication path that connects between adjacent distributed processing nodes; and
a higher-order aggregation network that connects between the M lower-order aggregation networks, wherein the higher-order aggregation network comprises:
a higher-order aggregation node; and
a higher-order communication path that connects between the higher-order aggregation node and 1st distributed processing nodes belonging to the lower-order aggregation networks;
wherein the distributed processing nodes belonging to the lower-order aggregation networks are each configured to generate distributed data for each of P weights w[p] (p=1, . . . , P) of a neural network that is a learning target of an own node, wherein P is an integer of 2 or greater;
wherein the 1st distributed processing nodes belonging to the lower-order aggregation networks are configured to transmit distributed data generated at the own node to a 2nd distributed processing node belonging to a same lower-order aggregation network, as first aggregated data;
wherein k′th (k=2, . . . , N[m]) distributed processing nodes belonging to the lower-order aggregation networks are configured to generate first aggregated data after updating, by finding a sum of first aggregated data received from a (k−1)′th distributed processing node belonging to the same lower-order aggregation network and distributed data generated by the own node for each corresponding weight w[p], and to transmit this first aggregated data to a k⁺′th (where k⁺=k+1, except for where k=N[m], in which case k⁺=1) distributed processing node belonging to the same lower-order aggregation network;
wherein the 1st distributed processing nodes belonging to the lower-order aggregation networks are configured to transmit the first aggregated data received from an N[m]′th distributed processing node belonging to the same lower-order aggregation network to the higher-order aggregation node as second aggregated data;
wherein the higher-order aggregation node is configured to generate third aggregated data by finding the sum of the second aggregated data received from the 1st distributed processing nodes belonging to the lower-order aggregation networks for each corresponding weight w[p], and to transmit this third aggregated data to the 1st distributed processing nodes belonging to the lower-order aggregation networks;
wherein the 1st distributed processing nodes belonging to the lower-order aggregation networks are configured to transmit the third aggregated data received from the higher-order aggregation node to the N[m]′th distributed processing node belonging to the same lower-order aggregation network;
wherein the k′th distributed processing nodes belonging to the lower-order aggregation networks are configured to transmit the third aggregated data received from the k⁺′th distributed processing nodes belonging to the same lower-order aggregation network to the (k−1)′th distributed processing node belonging to the same lower-order aggregation network;
wherein the 1st distributed processing nodes belonging to the lower-order aggregation networks are configured to receive the third aggregated data from the 2nd distributed processing node belonging to the same lower-order aggregation network; and
wherein the distributed processing nodes are configured to update the weights w[p] of the neural networks based on the third aggregated data that is received.

11. The distributed processing system according to claim 10, wherein the 1st distributed processing node belonging to an m′th (m=1, . . . , M) lower-order aggregation network includes:
a first communication port that is capable of bidirectional communication at the same time with an n⁺′th (where n⁺=n+1, except for where n=N[m], in which case n⁺=1) distributed processing node belonging to the same lower-order aggregation network;
a second communication port that is capable of bidirectional communication at the same time with an n⁻′th (where n⁻=n−1, except for where n=1, in which case n⁻=N[m]) distributed processing node belonging to the same lower-order aggregation network; and
a third communication port that is capable of bidirectional communication at the same time with the higher-order aggregation node.

12. The distributed processing system according to claim 11, wherein:
a k′th distributed processing node belonging to the m′th lower-order aggregation network includes the first communication port and the second communication port; and
the higher-order aggregation node is provided with M fourth communication ports that are capable of bidirectional communication at the same time with the lower-order aggregation networks.

13. The distributed processing system according to claim 12, wherein the distributed processing nodes each include:
an in-node aggregation processor configured to generate the distributed data;
a first transmitter configured to transmit the first aggregated data from the first communication port of the own node to the 2nd distributed processing node belonging to the same lower-order aggregation network in a case where the own node functions as the 1st distributed processing node belonging to the lower-order aggregation networks and to transmit the first aggregated data after updating from the first communication port of the own node to the k⁺′th distributed processing node belonging to the same lower-order aggregation network in a case where the own node functions as the k′th distributed processing node belonging to the lower-order aggregation networks;
a first receiver configured to receive the first aggregated data from the N[m]′th distributed processing node belonging to the same lower-order aggregation network via the second communication port of the own node;
a second transmitter configured to transmit the second aggregated data from the third communication port of the own node to the higher-order aggregation node in a case where the own node functions as the 1st distributed processing node belonging to the lower-order aggregation networks;
a second receiver configured to receive the third aggregated data from the higher-order aggregation node via the third communication port of the own node in a case where the own node functions as the 1st distributed processing node belonging to the lower-order aggregation networks;
a third transmitter configured to transmit the third aggregated data received from the higher-order aggregation node to the N[m]′th distributed processing node belonging to the same lower-order aggregation network via the second communication port of the own node in a case where the own node functions as the 1st distributed processing node belonging to the lower-order aggregation networks and to transmit the third aggregated data received from the k⁺′th distributed processing node belonging to the same lower-order aggregation network to the (k−1)′th distributed processing node belonging to the same lower-order aggregation network via the second communication port of the own node in a case where the own node functions as the k′th distributed processing node belonging to the lower-order aggregation networks;
a third receiver configured to receive the third aggregated data from the 2nd distributed processing node belonging to the same lower-order aggregation network via the first communication port of the own node in a case where the own node functions as the 1st distributed processing node belonging to the lower-order aggregation networks and to receive the third aggregated data from the k⁺′th distributed processing node belonging to the same lower-order aggregation network via the first communication port of the own node in a case where the own node functions as the k′th distributed processing node belonging to the lower-order aggregation networks;
a first aggregated data generator configured to generate the first aggregated data after updating in a case where the own node functions as the k′th distributed processing node belonging to the lower-order aggregation networks; and
a weight updating processor configured to update the weight w[p] of the neural network based on the third aggregated data that is received.

14. The distributed processing system according to claim 13, wherein the higher-order aggregation node includes:
a fourth receiver configured to receive the second aggregated data from the 1st distributed processing nodes belonging to the lower-order aggregation networks via the fourth communication port of the own node;
a second aggregated data generator configured to generate the third aggregated data by finding a sum of the second aggregated data received from the 1st distributed processing nodes belonging to the lower-order aggregation networks, for each corresponding weight w[p]; and
a fourth transmitter configured to transmit the third aggregated data from the fourth communication port of the own node to the 1st distributed processing nodes belonging to the lower-order aggregation networks.

15. A distributed processing system, comprising:
M lower-order aggregation networks, wherein M is an integer of 2 or greater, wherein the lower-order aggregation networks comprise:
N[m] (m=1, . . . , M) distributed processing nodes disposed in a ring form, wherein N[m] is an integer of 2 or greater; and
a lower-order communication path that connects between adjacent distributed processing nodes; and
a higher-order aggregation network that connects between the M lower-order aggregation networks, wherein the higher-order aggregation network comprises a higher-order communication path that connects between 1st distributed processing nodes belonging to the lower-order aggregation networks;
wherein the distributed processing nodes belonging to the lower-order aggregation networks are each configured to generate distributed data for each of P weights w[p] (p=1, . . . , P) of a neural network that is a learning target of an own node, wherein P is an integer of 2 or greater;
wherein the 1st distributed processing nodes belonging to the lower-order aggregation networks are configured to transmit distributed data generated at the own node to a 2nd distributed processing node belonging to a same lower-order aggregation network, as first aggregated data;
wherein k′th (k=2, . . . , N[m]) distributed processing nodes belonging to the lower-order aggregation networks are configured to generate first aggregated data after updating, by finding a sum of first aggregated data received from a (k−1)′th distributed processing node belonging to the same lower-order aggregation network and distributed data generated by the own node for each corresponding weight w[p], and to transmit this first aggregated data to a k⁺′th (where k⁺=k+1, except for where k=N[m], in which case k⁺=1) distributed processing node belonging to the same lower-order aggregation network;
wherein the 1st distributed processing node belonging to a 1st lower-order aggregation network is configured to transmit the 1st aggregated data received from a N[1]′th distributed processing node belonging to the same lower-order aggregation network to the 1st distributed processing node belonging to a 2nd lower-order aggregation network, as second aggregated data;
wherein the 1st distributed processing node belonging to a j′th lower-order aggregation network (j=2, . . . , M) is configured to generate second aggregated data after updating, by finding a sum of second aggregated data received from the 1st distributed processing node belonging to a (j−1)′th lower-order aggregation network and first aggregated data received from an N[j]′th distributed processing nodes belonging to the same lower-order aggregation network, for each weight w[p], and to transmit this second aggregated data to the 1st distributed processing node belonging to a j⁺′th (where j⁺=j+1, except for where j=M, in which case j⁺=1) lower-order aggregation network;
wherein the 1st distributed processing node belonging to the 1st lower-order aggregation network is configured to transmit the second aggregated data received from the 1st distributed processing node belonging to an M′th lower-order aggregation network to the 1st distributed processing node belonging to the M′th lower-order aggregation network as third aggregated data;
wherein the 1st distributed processing node belonging to the j′th lower-order aggregation network is configured to transmit the third aggregated data received from the 1st distributed processing node belonging to the j⁺′th lower-order aggregation network to the 1st distributed processing node belonging to the (j−1)′th lower-order aggregation network, and also to transmit the third aggregated data to the N[j]′th distributed processing node belonging to the same lower-order aggregation network;
wherein the 1st distributed processing node belonging to the 1st lower-order aggregation network is configured to transmit the third aggregated data received from the 1st distributed processing node belonging to the second lower-order aggregation network to the N[1]′th distributed processing node belonging to the same lower-order aggregation network;
wherein the k′th distributed processing node belonging to the lower-order aggregation networks is configured to transmit the third aggregated data received from the k⁺′th distributed processing node belonging to the same lower-order aggregation network to the (k−1)′th distributed processing node belonging to the same lower-order aggregation network;
wherein the 1st distributed processing nodes belonging to the lower-order aggregation networks are configured to receive the third aggregated data from the 2nd distributed processing node belonging to the same lower-order aggregation network; and
wherein the distributed processing nodes are configured to update the weights w[p] of the neural networks based on the third aggregated data that is received.

16. The distributed processing system according to claim 15, wherein the 1st distributed processing node belonging to an m′th (m=1, . . . , M) lower-order aggregation network includes:
a first communication port that is capable of bidirectional communication at the same time with an n⁺′th (where n⁺=n+1, except for where n=N[m], in which case n⁺=1) distributed processing node belonging to the same lower-order aggregation network;
a second communication port that is capable of bidirectional communication at the same time with an n⁻′th (where n⁻=n−1, except for where n=1, in which case n⁻=N[m]) distributed processing node belonging to the same lower-order aggregation network;
a third communication port that is capable of bidirectional communication at the same time with a 1st distributed processing node belonging to an m⁺′th (where m⁺=m+1, except for where m=M, in which case m⁺=1) lower-order aggregation network; and
a fourth communication port that is capable of bidirectional communication at the same time with a 1st distributed processing node belonging to an m⁻′th (where m⁻=m−1, except for where m=1, in which case m⁻=M) lower-order aggregation network.

17. The distributed processing system according to claim 16, wherein a k′th distributed processing node belonging to the m′th lower-order aggregation network includes the first communication port and the second communication port.

18. The distributed processing system according to claim 17, wherein the distributed processing nodes each further include:
an in-node aggregation processor configured to generate the distributed data;
a first transmitter configured to transmit the first aggregated data from the first communication port of the own node to the 2nd distributed processing node belonging to the same lower-order aggregation network in a case where the own node functions as the 1st distributed processing node belonging to the lower-order aggregation networks, and to transmit the first aggregated data after updating from the first communication port of the own node to the k⁺′th distributed processing node belonging to the same lower-order aggregation network in a case where the own node functions as the k′th distributed processing node belonging to the lower-order aggregation networks;
a first receiver configured to receive the first aggregated data via the second communication port of the own node;
a first aggregated data generator configured to generate the first aggregated data after updating in a case where the own node functions as the k′th distributed processing node belonging to the lower-order aggregation networks;
a second transmitter configured to transmit the first aggregated data received from the N[1]′th distributed processing node belonging to the same lower-order aggregation network to the 1st distributed processing node belonging to the 2nd lower-order aggregation network from the third communication port of the own node, as the second aggregated data, in a case where the own node functions as the 1st distributed processing node belonging to the 1st lower-order aggregation network, and to transmit the second aggregated data after updating to the 1st distributed processing node belonging to the j⁺′th lower-order aggregation network from the third communication port of the own node, in a case where the own node functions as the 1st distributed processing node belonging to the j′th lower-order aggregation network;
a second receiver configured to receive the second aggregated data via the fourth communication port of the own node in a case where the own node functions as the 1st distributed processing node belonging to the lower-order aggregation networks;
a second aggregated data generator configured to generate the second aggregated data after updating in a case where the own node functions as the 1st distributed processing node belonging to the j′th lower-order aggregation network;
a third transmitter configured to transmit the second aggregated data received from the 1st distributed processing node belonging to the M′th lower-order aggregation network to the 1st distributed processing node belonging to the M′th lower-order aggregation network from the fourth communication port of the own node, as the third aggregated data, in a case where the own node functions as the 1st distributed processing node belonging to the 1st lower-order aggregation network, and to transmit the third aggregated data received from the 1st distributed processing node belonging to the j⁺′th lower-order aggregation network to the 1st distributed processing node belonging to the (j−1)′th lower-order aggregation network via the fourth communication port of the own node, in a case where the own node functions as the 1st distributed processing node belonging to the j′th lower-order aggregation network;
a third receiver configured to receive the third aggregated data via the third communication port of the own node in a case where the own node functions as the 1st distributed processing node belonging to the lower-order aggregation networks;
a fourth transmitter configured to transmit the third aggregated data received from the 1st distributed processing node belonging to the 2nd lower-order aggregation network to the N[1]′th distributed processing node belonging to the same lower-order aggregation networks from the second communication port of the own node in a case where the own node functions as the 1st distributed processing node belonging to the 1st lower-order aggregation network, to transmit the third aggregated data received from the 1st distributed processing node belonging to the j⁺′th lower-order aggregation network to the N[j]′th distributed processing node belonging to the same lower-order aggregation networks from the second communication port of the own node in a case where the own node functions as the 1st distributed processing node belonging to the j′th lower-order aggregation network, and to transmit the third aggregated data received from the k⁺′th distributed processing node belonging to the same lower-order aggregation network to the (k−1)′th distributed processing node belonging to the same lower-order aggregation networks from the second communication port of the own node in a case where the own node functions as the kth distributed processing node belonging to the lower-order aggregation networks;
a fourth receiver configured to receive the third aggregated data from the 2nd distributed processing node belonging to the same lower-order aggregation network via the first communication port of the own node in a case where the own node functions as the 1st distributed processing node belonging to the lower-order aggregation networks; and
a weight updating processor configured to update the weight w[p] of the neural network based on the third aggregated data that is received.
